(19) United States
(12) Patent Application Publication
(10) Pub. No.: US 2024/0370909 A1
(43) Pub. Date: Nov. 7, 2024

(54) INTELLIGENT SYSTEMS TO OPTIMIZE CLOUD PROVIDER COMMITMENT COVERAGE FOR MAXIMUM EFFICIENCY

(71) Applicant: DoiT International USA, Inc., Santa Clara, CA (US)

(72) Inventors: Sebastian Amrogowicz, Ilford (GB); Aveer Ramnath, Johannesburg (ZA); Vadim Solovey, Tel Mond (IL)

(21) Appl. No.: 18/656,037

(22) Filed: May 6, 2024

Related U.S. Application Data
(60) Provisional application No. 63/464,078, filed on May 4, 2023.

(51) Int. Cl. G06Q 30/04

(52) U.S. Cl. CPC G06Q 30/04

(57) ABSTRACT

A method includes receiving, by a facilitator system (“FS”), a BDE for a customer of a cloud service provider, processing the BDE to determine a customer workload coverage need, determining an optimal blend of commitments needed, joining accounts owned by the FS to the customer's organization in response, where at least one commitment is held in each FS's account, and monitoring the customer's workload coverage needs to detect a change. In response to the change, the method further includes adding accounts to, or subtracting accounts from (in whole or in part), the customer's organization. A system contains instructions stored in memory that, when executed, cause one or more processors to receive N-days of on-demand workload usage for a customer; calculate a stable usage baseline based thereon; calculate a target coverage for the customer, and allocate a set of customer use discounts (“CUDs”) to cover the target coverage.

### CROSS-REFERENCE TO RELATED APPLICATIONS

This application claims the benefit of U.S. Provisional Patent Application No. 63/464,078, filed on May 4, 2023, entitled “INTELLIGENT SYSTEMS TO OPTIMIZE CLOUD PROVIDER COMMITMENT COVERAGE FOR MAXIMUM EFFICIENCY,” the entire disclosure of which (including the Appendix) is hereby incorporated herein in its entirety.

### TECHNICAL FIELD

The present invention relates to machine learning based optimizations, in particular to systems and methods to optimally distribute a blend of various cloud provider commitment types across a range of customers without the need for such customers to purchase their own commitments.

### BACKGROUND

Businesses and entities increasingly need to store data and applications in the cloud. Any enterprise with online sales platforms, or with significant other types of online customer interactions, such as, for example, insurance companies, banks and brokerages, as well as educational institutions and medical providers, all rely heavily on cloud-based systems to provide their respective services as well as online customer facing interactions. To facilitate their online presence, such entities utilize cloud provider services, such as, for example, Amazon Web Services, known as “AWS,” Microsoft's “Azure,” Google Cloud Platform (“GCP”), and IBM Cloud, to name a few.

Cloud providers have different fee arrangements, including, for example, dollars per hour. They also generally offer commitments, which is a kind of “bulk purchase.” A commitment is a contractual obligation between user and cloud provider to spend a certain amount of resources, either as dollars per hour or specific SKU, each hour for the duration of the commitment, in exchange for a discount. A metric of how much of a commitment is actually used is its utilization, which measures the portion of a commitment that was used by the user or customer.

A commitment generally requires committing to a stable spend for a duration of from one to three years. If workloads go down over time, customers are risking losing money by having to pay for those commitments—even if not used. However, if customers do not buy commitments, then they are forced to pay on-demand prices, which are higher. Commitments may be referred to as “Committed Use Discounts” or CUDs.

However, many cloud users do not realize full utilization on their commitments. In fact, standard utilizations of such commitments are understood to be significantly less than 100% l, on average, over the time interval of the commitment. As a result, customers tend to cover less of their on-demand workloads with commitments.

Therefore, what is needed in cloud computing technology is a way for cloud provider customers to obtain the benefits of commitments, but to also optimize their use to achieve essentially full utilization.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

The patent or application file contains at least one drawing executed in color. Copies of this patent or patent application publication with color drawing(s) will be provided by the Office upon request and payment of the necessary fee.

FIG. 1A depicts an exemplary AWS organization according to an exemplary embodiment.

FIG. 1B depicts a process flow diagram for an example bottom up optimization process, according to various embodiments.

FIG. 2 depicts a first portion of a process flow diagram for a detailed bottom up optimization process, according to various embodiments.

FIG. 3 depicts a second portion of the process flow diagram shown in FIG. 2.

FIG. 4 depicts a process flow diagram for a top down optimization process, according to various embodiments.

FIG. 5 depicts example historical data for on demand usage and an example predicted stable usage baseline, according to various embodiments.

FIG. 6 illustrates, using a baseline such as is shown in FIG. 5, calculation of a potential available for all workloads.

FIG. 7 is an augmented version of the process flow diagram of FIG. 1A to include the use of real-time data.

FIG. 8A depicts a comparison of on demand usage with commitment resources according to an optimization using data obtained at predefined intervals as inputs; and

FIG. 8B depicts a comparison of on demand usage with commitment resources according to an optimization which uses real-time data as inputs.

FIG. 9 depicts an example of a customer's on-demand usage of VCPU for a two week period.

FIG. 10 depicts the same customer's usage after optimization by Flexsave, in accordance with various embodiments.

FIG. 11 illustrates moving DoiT owned GCP projects into customers' billing accounts, in accordance with a Flexsave embodiment for a Google Cloud Platform (“GCP”).

FIG. 12 illustrates restrictions on moving CUDs, based on which SKUs a given CUD was purchased for.

FIG. 13 depicts an exemplary system architecture for the GCP Flexsave embodiment, including an API backend and an AI optimizer.

FIG. 14 illustrates a stable usage baseline, using 30 days of data.

FIG. 15 illustrates some examples of determining a new 30 day baseline from total hourly on demand data.

FIG. 16 illustrates a 24 hour validation process, in accordance with various embodiments.

FIG. 17 illustrates purchasing CUDs within a pre-defined safety margin, in accordance with various embodiments.

FIG. 18 illustrates, using a target baseline and a stable baseline, calculation of an available potential for all workloads.

FIG. 19 depicts an example of coverage, in accordance with various embodiments.

FIG. 20 depicts example optimization steps, in accordance with various embodiments.

FIG. 21, which is the same as FIG. 6 described above, illustrates the distribution of CUDs amongst BAs, in accordance with various embodiments.

FIG. 22 illustrates an example where, for a given SKU, over-provisioned CUDs are moved to under-provisioned billing accounts.

FIG. 23 depicts an exemplary “spiky” workload that has significant variation in total on-demand workload.

FIG. 24 depicts an exemplary first optimization run, to get each workload to its specified target coverage.

FIG. 25 depicts an exemplary second optimization run, to spread any over-provisioning amongst customers.

FIG. 26 illustrates how over-provisioning can still remain after 100% coverage is obtained.

FIG. 27 illustrates an exemplary moving optimum approach for optimizing coverage, according to one or more embodiments, where an example customer's usage varies significantly over a 24 hour period.

FIG. 28 illustrates the exemplary moving optimum approach of FIG. 27, for a more stable/predictable customer, where the values for 24 hours and each 6 hour window are very close.

FIG. 29A is a first section of a process flow diagram for optimizing the distribution of commitment inventory.

FIG. 29B is a second section of the process flow diagram shown in FIG. 29A.

### DETAILED DESCRIPTION

Systems and methods for facilitating and managing the collective use of one or more commitments by multiple entities are presented herein. In one or more embodiments, the benefits of commitments may be enjoyed while maintaining a very high utilization. In embodiments, an intermediary or facilitating system may be used which customers of cloud service providers may associate with, as customers also of the facilitating system. In several of the descriptions provided below, various embodiments of such a facilitating system will be referred to as “Flexsave.” In some descriptions herein, the applicant's brand name “DoiT” will also be used to designate an example intermediary or facilitating system, or its owner/provider. DoiT is a brand name used by the applicant hereof, and Flexsave is one of its services.

Flexsave allows customers to receive a discount on qualifying workloads by utilizing a DoiT owned inventory of commitments. This inventory can be dynamically moved between DoiT customers, thereby allowing the DoiT customers to either lower, or increase, their usage for a period of time. This allows such customers to receive the benefit of the commitment discount but without the risk of still paying for commitments later, after their usage has gone down.

In the following detailed description, reference is made to the accompanying drawings which form a part hereof wherein like numerals designate like parts throughout, and in which is shown by way of illustration embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is to be defined by appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). 70670

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

In one or more embodiments, Flexsave is an automated system which uses AI and machine learning to distribute an optimal blend of various commitment types across a range of customers to maximize savings, without the need for a commitment from the customer (i.e., without the need for the customer to buy their own commitment directly from the cloud service provider).

Depending on the cloud service provider, Flexsave can use various commitment types (e.g., those that vary by purchase type, duration, or other criteria) that may be purchased in accounts or projects. The Flexsave commitments may then be moved between customer owned organizations or billing accounts to achieve a best, or optimal, coverage that takes into account changing customer workloads, existing commitments and forecasted usage. In one or more embodiments, Flexsave may generate savings on cloud computing workloads without requiring any changes to either customer infrastructure or the customer's existing workloads. In short, the described system generates customer savings flexibly, hence the name “Flexsave.”

In various embodiments, Flexsave's techniques may be applied to any cloud service provider. For ease of illustration of various Flexsave functionalities, in what follows two illustrative exemplary embodiments are described, one for example customers of Amazon Web Services (“AWS”) and another for example customers of Google Cloud Platform (“GCP”). Nonetheless, it is understood that these examples are merely illustrative, and Flexsave may be applied to any cloud provider that offers commitments with accompanying discounts relative to straight on-demand could services.

In what follows, a Flexsave for AWS example is initially described, followed by a description of a Flexsave GCP example. As noted above, neither are to be understood as limiting, each being merely exemplary.

### Flexsave for AWS

### Introduction

Flexsave for AWS requires customers to have an AWS Organization configured with both the consolidated billing feature set and discount sharing enabled. As regards various embodiments, an AWS Organization may be understood as follows:
AWS Organizations is an account management service that enables you to consolidate multiple AWS accounts into an organization that you create and centrally manage. AWS Organizations includes account management and consolidated billing capabilities that enable you to better meet the budgetary, security, and compliance needs of your business. As an administrator of an organization, you can create accounts in your organization and invite existing accounts to join the organization.

See, for example, the following URL (after removing the XXX): https://docs.aws.amazon.com/organizations/latest/XXX_userguide/orgs_introduction.html.

Additionally, consolidated billing is a feature of AWS where one may treat spend from all accounts under the same organization as if they originated from a single account. Thus, any volume discount, tiered pricing or commitment discount may be applied to all combined spend in all accounts, regardless of where (i.e., in which account) the spend originated. See, for example, the content at the following URL: https://docs.aws.amazon.com/awsaccountbilling/latest/XXX_aboutv2/consolidated-billing.html

Next described are some background details of AWS commitments, which are useful to understand the optimizations described below, according to various embodiments.

There are two types of commitments offered by AWS: Savings Plans and Reserved Instances. Each of these are described at https://aws.amazon.com in detail, and need not be repeated here. In exchange for a customer's commitment to spend or use a certain amount of resource each hour for a duration of time, AWS offers a discount. Importantly, there is a required per hour spend, and the customer may not finish faster by using more resources earlier. Both AWS commitment types have the following common features:
May be purchased for either 3 years (higher savings) or 1 year (lower savings); and
May be purchased as either:
   All Upfront—full payment for the term when you the purchase is made (higher savings);
   Partial Upfront—50% payment on purchase and remaining 50% distributed hourly over the term of the purchase (mid-level savings); or
   No Upfront, where all costs are charged hourly as a proportion of the term cost.

Additionally, the following features are specific to the AWS ReservedInstances type of commitment:
May be purchased for only one of the AWS supported services (i.e., EC2 or RDS);
May be purchased for use of a specific resource (i.e., 30 instances of m5.×large machine with Linux); and
May be purchased for a specific region or zone.

There is also a variant of this commitment type known as a Convertible Reserved Instance, for the EC2 service only, which allows the customer to change the type of purchased reservation within parameters to a different one. See Exchange Convertible Reserved Instances—Amazon Elastic Compute Cloud for details.

Finally, the following features are specific to the Savings Plans type commitment:
Customer commits to a specific amount of dollars per hour at a discounted rate specific to that Savings Plan rate; and
Savings Plans may apply to more than one service, or they may be restricted to selected SKUs.

### Flexsave AWS In Operation

In embodiments, Flexsave dynamically attaches accounts to an AWS Organization that contains various commitments. The commitments are then shared with all customer owned accounts under the same Organization, thus generating savings for all workloads.

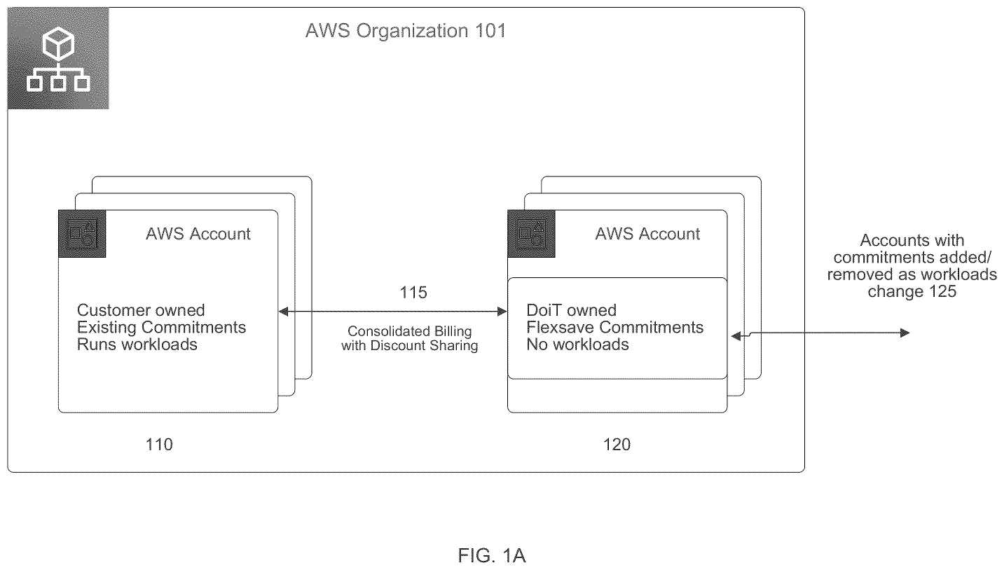

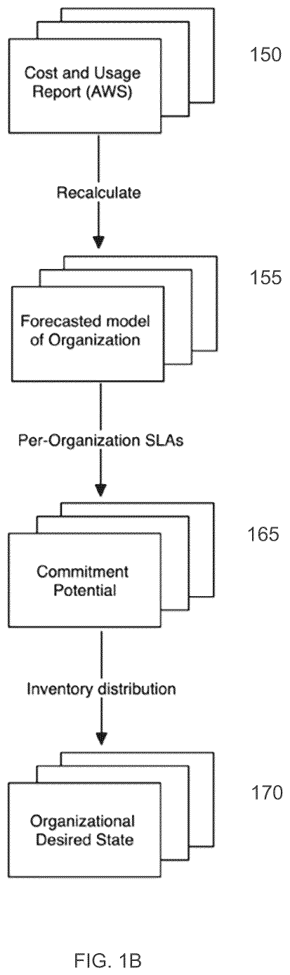

FIG. 1 depicts an example AWS organization 101, according to various embodiments. With reference to FIG. 1, there are shown customer owned accounts 110, for which both consolidated billing and discount sharing are enabled, as shown by arrow 115. The customer accounts 110 run various workloads. There are also shown several DoiT (system provider) owned accounts 120, which include Flexsave commitments, but the DoiT accounts are not assigned any workloads.

In embodiments, each AWS Account used by Flexsave contains a single commitment with different hourly granularity. In embodiments, as shown at 125, Flexsave may dynamically adjust the commitment needed by the customer by moving enough accounts in or out of the AWS organization 101 to achieve optimal coverage.

The optimal coverage required for an organization depends heavily on the workloads run and is generally impacted by: region workloads run, compute specification of the workloads, operating system of the workloads, commitment type, commitment length, purchase type of the commitment—coming from DoiT, contractual discounts provided to the organization based on the contract with the cloud provider (either flat discounts or SKU level discounts), and existing commitments purchased by the customer.

In embodiments, Flexsave for AWS may operate using all AWS provided commitment mechanisms, including standard or convertible reservations, as well as savings plans. Standard/Convertible Reservations are historically an older commitment type, which requires specification of certain parameters of the workloads covered and which applies only to those. Some commitments do allow changing attributes of covered workloads, but this is not done dynamically based on actual workloads covered.

Savings Plans are a newer form of commitment, which requires specifying the commitment at dollar per hour at a discounted rate; however, depending on the savings plan type, this commitment type can be allocated more dynamically so as to generate savings.

In embodiments, once workloads are covered, Flexsave uses the AWS Cost and Usage Report to calculate the fee. Depending on needs, workloads covered by Flexsave may be converted to a new rate that is specific to what the customer will be paying, or, for example, a new fee can be added to the report, representing DoiT margin or cost of generating coverage (i.e., when covered by commitments paid outside of the AWS Organization in which the savings were generated). In embodiments, additional processing can remove any underutilization caused by Flexsave to either customer owned commitments or Flexsave owned commitments.

So, for example, as shown in FIG. 1A, DoiT may purchase commitments in its own accounts from the Cloud Vendor (AWS), where each account carries a certain amount of commitment per hour of a specific type. In embodiments, DoiT may, for example, own thousands of accounts holding commitments ranging from $0.5/h to $25 per hour, of various types, for both Spend Based Commitments and a variety of Resource Based Commitments. However, no workloads run in the accounts owned by DoiT that carry those commitments.

Then, for example, DoiT may determine the need for the coverage in customer organization. As per the consolidated billing feature mentioned above, DoiT may look at the whole spend in the organization and determine an optimal blend of commitments needed by the customer, available inventory and risk associated with workloads.

Then, for example, in such embodiments, DoiT joins accounts that it owns to the customer organization. Due to the consolidated billing feature that has been enabled, commitments in the DoiT accounts (with no workloads) are then shared with workloads running in customer accounts. There is no need to change how the workloads work, because the DoiT owned commitments can cover workloads in the customer accounts.

In embodiments, DoiT continuously monitors the need to adjust coverage for a customer—either up or down—and, in response, either adds or removes accounts from the customer organization as usage changes.

Advantage of Flexsave Over Customers Obtaining their Own Commitments

The management of commitments by a DoiT type facilitating system offers several improvements and efficiencies that are simply not available at an individual customer's scale. Thus, while customers can purchase their own commitments, they need to be purchased for either a one year or a three year term. If the customer's usage drops sometime after purchase, say, 1-2 months into the commitment, then the customer loses money, because it has committed to a certain spend/usage per hour that is underutilized. It is noted that commitments are based on hourly spend/usage over a period of time, and the commitment owner cannot use the total usage covered by the commitment early. Thus, the customer cannot balance its total usage over the commitment term as it sees fit or desires, by increasing usage in busy months, and by dropping usage in slower months. It is this static aspect of commitments in the cloud service industry that Flexsave comes to make more flexible, and thus ameliorate. In various embodiments, DoiT allows a customer to receive a given commitment, say commitment X, for a period of time, and once the customer's usage goes down, DoiT may move commitment X, or a part of it, to a different customer for whom usage has gone up. In practice, because no customer gets 100% coverage by default (Flexsave aims for 85% coverage of total workloads) any temporary surplus of inventory may be dynamically redistributed between existing customers in that spare 15%.

Due to DoiT, the operator of Flexsave, or any equivalent entity, having a large volume of customers, in embodiments, Flexsave may easily add or remove those commitments that it owns as the spend changes for individual customers. Thus, Flexsave allows its customers (who are also customers of the cloud service provider) to benefit from the large scale that only a facilitating system can provide.

### Flexsave AWS Systems and Optimization Overview

Thus, in embodiments, the larger Flexsave for AWS systems comprises multiple AWS Organizations belonging to customers, where each customer can own any number of AWS Organizations. In embodiments, Flexsave for AWS attempts to find the right balance of coverage in the whole system while factoring existing constraints to maximize both customer coverage and DoiT revenue, such as, for example:
Existing inventory—DoiT owns a certain amount of commitments of different types which can be used with customers. Depending on the load in the system there may be too much or too little inventory at any given time;
Ensuring customer coverage does not cause waste to be paid by DoiT;
SLAs specified on different AWS Organizations, such as minimum or maximum coverage; and
Deciding best inventory type for each AWS Organization—for example, No Upfront inventory is better suited for customers with commitments due to discounts on Recurring Fees which improve DoiT revenue.

It is noted that a given customer usually has one AWS Organization. However, they may have multiple Organizations under certain circumstances, such as, for example, when acquisitions happen (the newly acquired company will keep their own organization), or separation by business unit, or one Organization for the externally facing application (to keep more restricted access and improved governance) and another Organization for back-office applications, such as R&D, etc., with looser access.

In embodiments, each AWS Organization is considered separate for the purpose of optimization, if there is some contractual service level agreement (“SLA”) for a customer that might impact multiple organizations, but it could be equally considered multiple separate SLAs. Outside of the fact that some SLA override can come from the same customer to multiple Organizations, in embodiments, an exemplary system considers each Organization separate and there is no tie to a customer.

The more organizations the system has, overall the better it works due to the power of scale, since the decrease/increase of need in individual organizations evens out more easily as the number of organizations increases. It is noted that because “AWS Organization” is a specific term, it is often capitalized in this disclosure to refer to that particular use in the AWS world. However, the AWS Organization has equivalent constructs in each CSP, and is also understood to be a general and generic “organization” of a customer of a CSP in the general sense, and is sometimes spelled in lower case letters, even when referring to an AWS customer entity.

DoiT recommends that each customer have only one organization, because having all of that customer's spend in a single organization helps with volume discounts and the like (since those are not applied across organizations), and thus allows the customer to negotiate better discounts with its cloud provider. However, if a customer has a business need for more organizations, DoiT does not advise against that, and all of that customer's organizations are then included in DoiT's optimization processing.

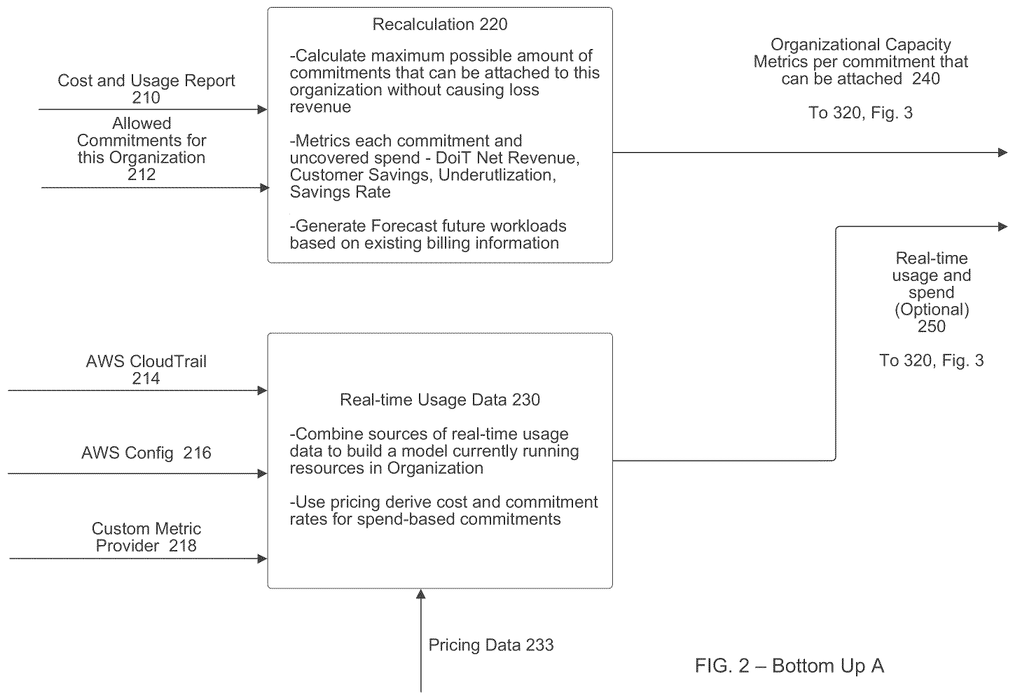

In embodiments, an exemplary Flexsave system achieves the best performance by performing a two-step optimization process. A first step of the optimization includes a Bottom-Up Optimization that is calculated for each AWS Organization in isolation to determine the possible coverage models for that AWS Organization. Then, a second optimization step includes a Top Down Optimization that is calculated for the entire Flexsave system (i.e., all Organizations that are serviced by Flexsave) to achieve the best overall system performance given constraints. These two optimization steps are next described, with reference to FIG. 1B, and the more detailed set of process flow charts shown in FIGS. 2-4.

FIG. 1B illustrates the total optimization used by Flexsave according to various embodiments. FIG. 1B applies to both the present Flexsave AWS example as well as to the Flexsave GCP example described below; for other cloud providers the CUR of block 150 would be replaced with the analogous or equivalent billing and usage data that that particular other cloud provider outputs or provides. Blocks 150 and 155 of FIG. 1B describe the bottom-up optimization process, and boxes 165 and 170 cover the top down optimization process. Each of these processes is next described.

### Bottom-Up Optimization

In embodiments, each AWS Organization is considered to be separate for the purpose of determining optimal coverage for that AWS Organization before any constraints of the system or SLAs are applied. This includes, as noted above, multiple organizations owned by the same single customer. In embodiments, the basis (or input to) the Flexsave optimization is the AWS Cost and Usage report (“CUR”) (see https://docs.aws.amazon.com/cur/latest/userguide/what-is-cur.html) at an hourly granularity with Resource IDs. This is shown, for example, at 150 of FIG. 1B.

The CUR is a bill issued from AWS that provides detailed information about all resources for which a customer is being billed. It contains information about the resource, associated SKU (“stock keeping unit” an inventory item identification), time for which it is charged, any resource specific metadata, and pricing and cost details for that resource.

In embodiments, based on the CUR, a series of three recalculations may be performed to determine the optimal coverage for various commitments customer can take:
(1) Initially, a determination may be made of the stable and qualifying spend based on the potentially available inventory over the qualifying period of time, both for already covered and uncovered workloads, as well as any historical underutilizations of commitment mechanisms of either customer of DoiT.
   The following are definitions of the technical terms used in connection with recalculation (1) above. Covered workloads refers to any resources that could qualify for discount under the commitments, which are already covered by either customer owned commitments or DoiT owned commitments (such workloads cannot be covered by any commitments twice). Uncovered workloads refers to resources that qualify for being covered by commitments but are currently running under on-demand pricing scheme. Inventory refers to commitments already purchased by DoiT and available to be used to cover workloads. Qualifying period of time refers to a minimal duration of information available about workloads running in an organization that allows us to determine what is stable spend. In embodiments, this may be taken to be between 7 and 30 days.
   Finally, historical underutilization refers to historical data about commitments in the organization not being fully used. Because each commitment represents a certain amount of resources or dollars spent each hour, AWS charges for it regardless of whether it was used. It is noted that this information indicates that not all of the commitments attached to the organization (or customer, as the case may be) were fully used, potentially losing some money.
(2) Depending on the commitment type, the order of application can change according to the cloud provider's rules. Because customers can have existing commitments which may be applied in a different order, in embodiments, Flexsave needs to simulate the exact behavior of their system if Flexsave were to add its inventory to the customer's system. Once Flexsave determines the maximum level of workload coverage that it can cover, Flexsave then simulates the impact the Flexsave inventory would have had on the AWS Organization in the past.

The following is an illustrative example of an order of application change, assuming the following facts:
Customer owns 1 Year No Upfront Compute Savings Plan of $1.00 per hour;
Customer runs m5.8×large Linux instance in us-east-1 and p3.2×large Linux instance in us-east-1; and
$1.00 of SP owned by customer will first cover 88.6% of usage of m5.8×large since it has a higher savings rate (27%) than p3.3×large (21%). The uncovered workloads will consist of $0.175 (11.4% of $1.536 at On-Demand rate) and $3.06 for p3.2×large running on-demand—total $3.235 on-demand.

Now, attaching $1 of Flexsave Inventory as 3 Year No Upfront Compute Savings Plan will change the order as follows:
The 3 Year Savings Plan will take priority and cover m5.8×large fully using $0.779 of the $1.00 attached, leaving $0.201 for the next workload;
The remaining DoiT commitment of $0.201 will cover 11.2% of p3.2×large instance (since the associated 3 Year rate is $1.795); and
$1.00 of the customer owned Savings Plan (“SP”) will now cover the remaining p3.2×large instance instead of the previously used m5.8×large—it will now cover 41.6% of the remaining p3.2×large usage (since we have $1.00 and the rate associated with this SP for that instance is $2.403). This will leave 47.2% of the p3.2×large instance as uncovered workload, charged $1.444 on demand (associated rate for on-demand is $3.06).

Thus, as described above, by attaching DoiT inventory, the customer owned commitment was moved to cover a lower savings rate instance.
(3) Following the above-described recalculations, based on the past usage, the optimal coverage for this account is determined using forecasted data based on past usage (such as, for example, trends, seasonality, etc.) to build a forecasted model of the organization showing the impact of each commitment added and the returns for the customer and for DoiT. In embodiments, such a model, shown at 155 of FIG. 1B, may be built using ML models that are trained to best predict future usage based on existing data.

In one or more embodiments, the following algorithm may be implemented for the bottom up optimization:
Start with the detailed bill (CUR) showing all resources with associated workloads;
Remove all commitments and generate a system in which all workloads are priced on-demand—aka everything is considered uncovered;
Determine all commitments owned by the customer and order them as they would be applied;
Order the workloads in the order they would get applied;
Apply all customer owned commitments that would have priority over what DoiT would like to attach to highest savings workloads until commitments run out;
Apply all customer owned commitments that would have lower priority over what DoiT would like to attach to lowest savings workloads (reverse application) ensuring they are properly utilized; and
The space between the higher rate commitments and lower rate commitments to which nothing was applied is now where DoiT commitments can be applied. Those workloads are committed to the rate associated with the DoiT commitments and it is determined how much can be attached.

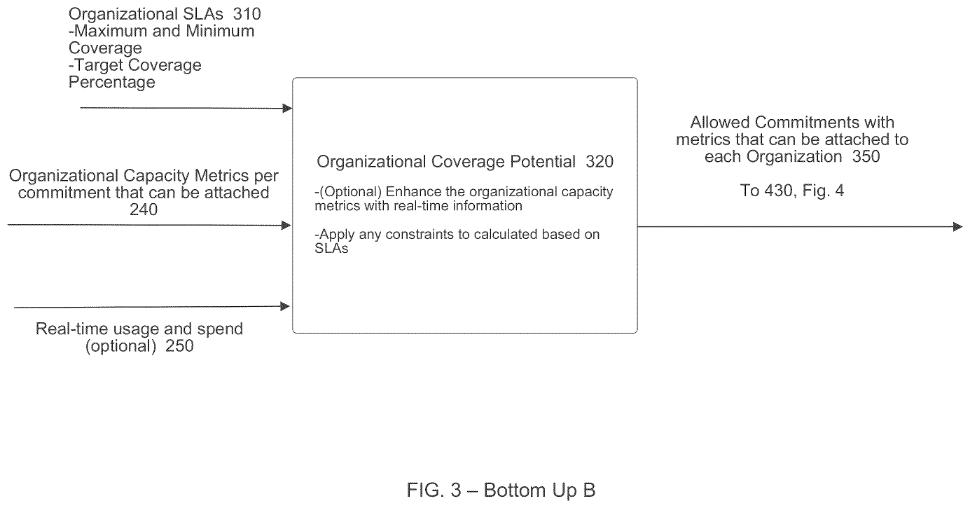

FIGS. 2 and 3 together present a detailed process flow chart for the bottom-up optimization process, in accordance with various embodiments, and implementing the algorithm described above. It is noted that due to lateral size, the overall bottom up optimization processing was split into two figures, labelled “Bottom Up A” and “Bottom Up B.” Thus, referencing the right side of FIG. 2 (processing moves from left to right in the figure), the output 240 of block 220, recalculation, is fed into block 320 of FIG. 3, organizational coverage potential, at the left side of FIG. 3. Similarly, if chosen to be generated, optional output 250 of block 230 of FIG. 2, real-time usage data, is also fed into block 320 of FIG. 3, organizational coverage potential, as shown at the left side of FIG. 3.

Next described is the last part of AWS Flexsave processing, the top down optimization.

### Top Down Optimization

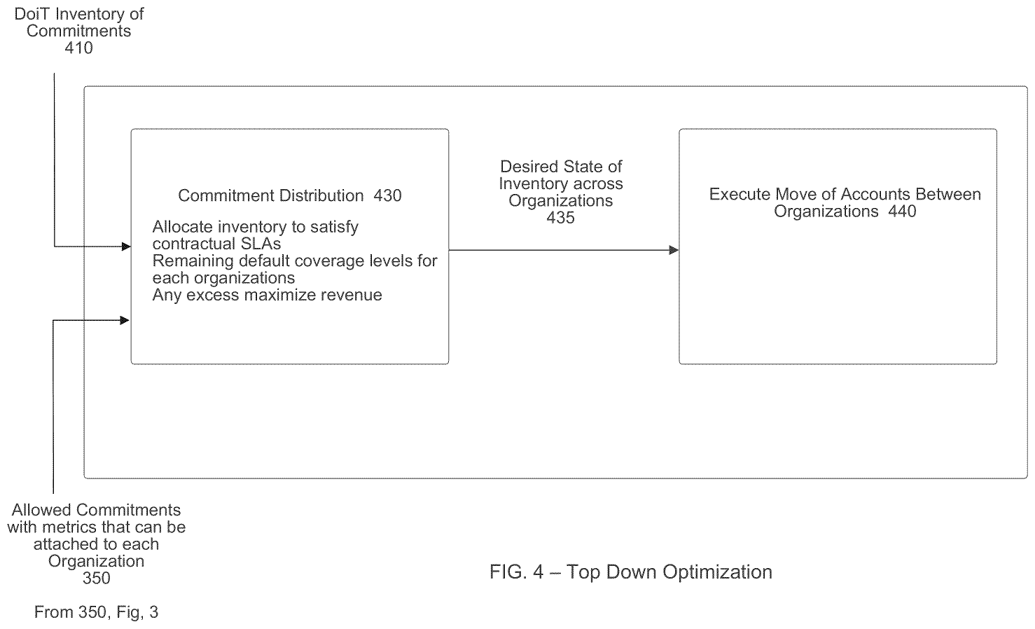

In embodiments, the information obtained from the bottom-up optimization phase may be used to generate the desired state of the whole system. This is shown at blocks 165 and 170 of FIG. 1B, and shown in greater detail in FIG. 4, where the output 350 of the final block of Bottom Up B, which is, in FIG. 3, block 320, organizational coverage potential, is fed into the right side of FIG. 4, as an input to block 430, commitment distribution. It is noted that the other input to block 430 of FIG. 4, DoiT inventory of commitments 410, is fed to block 430 from another source (it is a value continually stored and managed by the Flexsave system), and is not an output of the bottom up optimization process.

In embodiments, a top down optimization algorithm may be used to decide the distribution of commitments by using the per-Organization models and to apply the following rules:
Ensure any contractual minima or maxima for each account is met according to the SLA specified for that account.
Allocate commitments to all accounts to meet the desired default level of coverage.
   If the default cannot be met due to lack of inventory, prioritize workloads with highest ROI followed by the highest stability.
For any excess inventory over the default, prioritize workloads with highest revenue followed by stability.
In case existing inventory exceeds the capacity of the overall system to take it on, prioritize minimizing waste (workloads with highest utilization).

As used in the top down optimization, the following technical terms have the following meanings:
The default level of coverage specifies how much of the stable usage/spend will be covered by Flexsave in percentages.
Inventory refers to all purchased commitments available to be used by Flexsave to cover customer workloads.
Revenue of a workload refers to revenue made by covering specific workload after paying costs of commitments and any savings passed to the customer.
Finally, stability of a workload refers to stable spend/usage and is defined as running workloads that qualify for discounts from the qualifying commitments that over a period of time would generate positive savings if covered.

Next described is the second Flexsave example discussed above, where Flexsave technology is implemented for customers using the GCP.

### Flexsave GCP Overview

Flexsave for GCP works by leveraging the Commitment Sharing functionality of a Billing Account. Resource based commitments purchased in GCP Projects, which are part of a DoiT GCP Organization (see https://cloud.google.com/resource-manager/docs/cloud-platform-resource-hierarchy#organizations), may be dynamically attached to customers' Billing Accounts and cover the workloads of all projects attached to a customer Billing Account, regardless of GCP Organization structure of the workloads. A Billing Account is a logical grouping for the billing of a number of cloud services. A customer may have one or more billing accounts in their organization, although most often they have just one.

In embodiments, each project owned by Flexsave for GCP contains a small commitment of a specific type (single SKU) and nothing else. In embodiments, Flexsave can dynamically adjust the coverage required by attaching a number of projects with selected SKUs that match the desired coverage. This is because Flexsave may obtain permissions to move GCP projects into and out of a customer's billing account. Thus, in embodiments, Flexsave creates projects and adds commitments into the project. The process then moves the projects into and out of customers' billing accounts.

In one or more embodiments, the optimal coverage required for a Billing Account depends heavily on the workloads run, and is impacted by:
Region workloads run;
Computing specification of the workloads;
Contractual discounts provided to the Billing Account based on the contract with the cloud provider (either flat discounts or SKU level discounts); and
Existing commitments purchased by the customer.

In embodiments, a Flexsave for GCP system includes two key components: a Purchase Recommendation Engine (PRE) and an Optimization Engine (OE). In embodiments, the PRE may determine optimal coverage using, for example, 30 days of historical data. In such embodiments, the OE may manage daily changes in the usage to prevent waste and optimize the coverage.

### Purchase Recommendation Engine

In embodiments, the PRE (also referred to as “the recommender”) is responsible for producing recommendations as to the number of commitments to purchase. In such embodiments, the PRE may do this by examining historical data of usage, both at an individual billing account and at a system level. Additionally, it may include risk models and system inventory data to produce a recommendation. In embodiments, the algorithms run by the PRE may employ stochastic and machine learning techniques to provide the desired output.

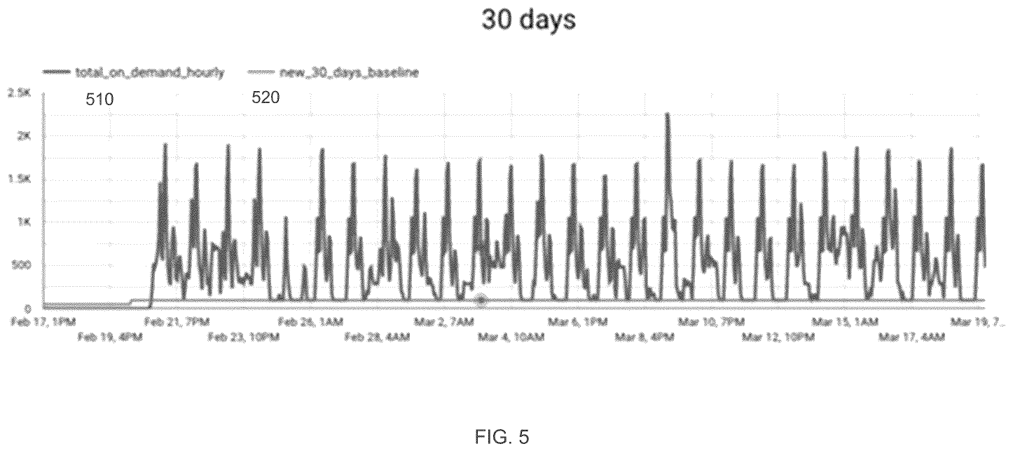

In embodiments, in order to recommend a commitment purchase, a model of historical stable usage is needed. The recommender may, for example, look at historical data of on-demand usage and employ machine learning techniques to predict a stable usage baseline for the workload. This is illustrated in FIG. 5, next described, which is a plot of on-demand usage 510 over a 30-day period. Also shown in FIG. 5 is a new 30-day baseline 520, that has been generated by the PRE from the data 510. It is noted that, in some embodiments, a stable usage baseline refers to the lower bound of the usage for a given period, ignoring dips that occur for less than 20% of the time interval. Other versions of a stable usage baseline may use different metrics for the on-demand data.

### Optimization Engine

In embodiments, the OE (“the optimizer”) is responsible for distributing the commitment inventory from Billing Accounts which are over-provisioned, to those which are under-provisioned. Each Billing Account has a predefined target coverage which the optimizer attempts to fulfill. In embodiments, in order to perform the optimization, the following steps may be taken:
(1) Determine a recent stable usage baseline; and
(2) Perform allocation of inventory.

### (1) Determining Recent Stable Usage Baseline

For this task, the optimizer looks at historical data of on-demand usage and employs machine learning techniques related to time series forecasting to predict a stable usage baseline for the workload for a recent time interval. An example input 510 and output 520 for this process is shown in FIG. 5.

### (2) Perform Allocation of Inventory

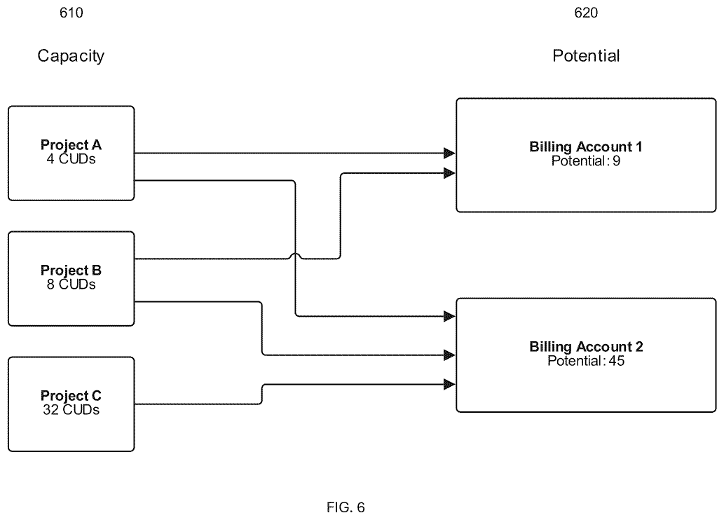

In embodiments, once stable usage baseline has been determined, the optimizer may calculate the potential available for all workloads. Thereafter, it may use this potential to perform the commitment allocations so as to satisfy a number of optimization targets. Such an exemplary calculation is illustrated in FIG. 6, where the capacity 610 for each of several projects is used as inputs to generate the potential 620 for all workloads. This process is detailed in Appendix A as well, at Slides 18-26. It is noted that FIG. 6 is actually taken from a portion of Slide 20 of Appendix A.

### Real-Time Strategy for Flexsave Optimization

It is noted that the above described embodiments utilize billing data exports (AWS CUR and GCP billing export) as primary data sources. However, these data sources suffer from an inherent delay in the production of the necessary data. In fact, the typical delay for billing data ranges from 12-36 hrs. Using this older, and not up to date, data can introduce prediction error, and skew the optimization.

In one or more embodiments, in order to cure this problem, an exemplary Flexsave system may be augmented to use near real-time data sources. It is noted that in order to use near real-time data sources, additional permissions are required from the customer. The typical delay for these near real-time data sources will generally range from 0-1 hours, excluding the time required to process the data.

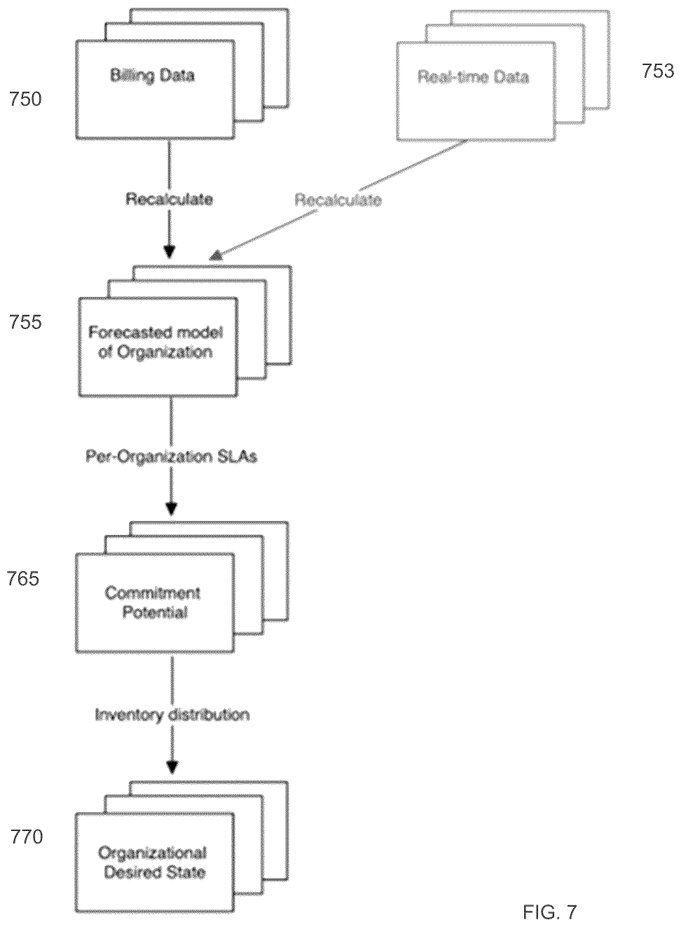

In this vein, FIG. 7 shows where the real-time data sources are integrated into the flow. With reference thereto, in FIG. 7 the new block “Real-time Data 153” is added to the process flow of FIG. 1B. The recalculated real-time data is thus an additional input to block 155, where the forecasted model of the organization is computed.

These real-time data sources contain information on the usage of cloud resources and commitments. Examples of the relevant data sources are: GCP Cloud Audit Log, AWS CloudTrail, AWS Cloud Watch, GCP Cloud Asset Inventory, and AWS Config, for example.

In embodiments such enhanced data sources enable the system to respond in near real-time to changes in cloud workloads and thus achieve improved performance.

### Example Illustrating Benefits of Real-Time Data for Optimization

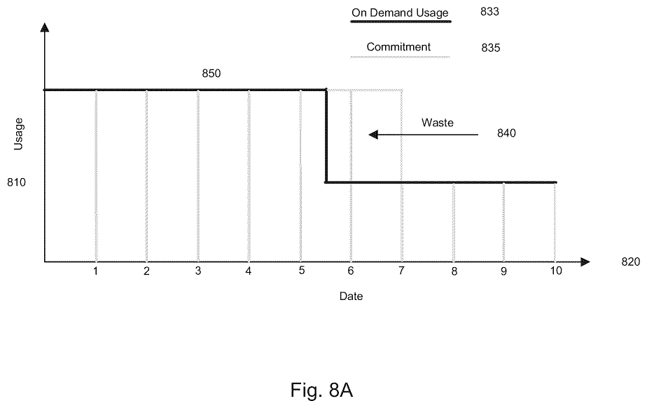

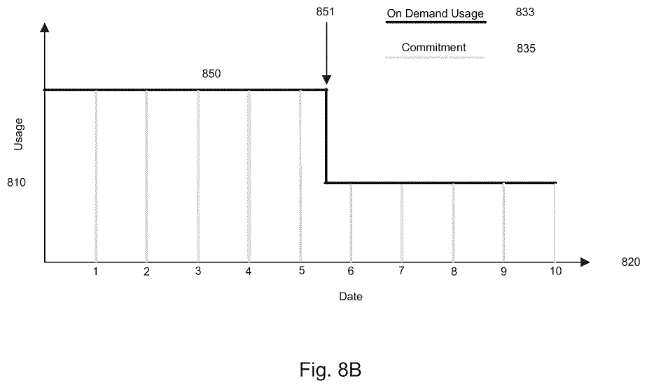

When the source of data is, as above, billing data exports, the existence of the inherent delay means that the system cannot immediately react to changes in workload. The case shown in FIG. 8A is illustrative, which shows a plot of usage 810 versus time (in days) 820. With reference to FIG. 8A, the on demand usage 833 (shown in black) decreases at midday on the 6th, at time point 850, but this decrease only reflects on billing data within 24-48 hrs. As such, Flexsave is not able to move the commitments 835 (shown in green) until the 8th. This will lead to waste 840, which is the difference between the commitments 835 and the actual on-demand usage 833. Thus, from time point 850 at midday on the 6^{th}, thorough the 8^{th}, the commitment is over-provisioned.

In comparison, real-time data would permit the change to be actioned within 1-2 hours, and the waste component is significantly reduced. This is illustrated in FIG. 8B, where the commitment is moved shortly after the real-time usage decreases at midnight of the 6^{th}, shown as time point 851, and thus tracks it essentially exactly. Thus, in the situation illustrated in FIG. 8B, there is no waste at all.

### Exemplary Flexsave for GCP Scenario

The following is a real-world example of Flexsave functionality for a GCP customer.

Consider a GCP customer, customer A, who uses the E2 compute workload in region us-east1, and makes use of e2-standard-8 instances, which consists of 8 VCPU and 32 GB of memory per instance.

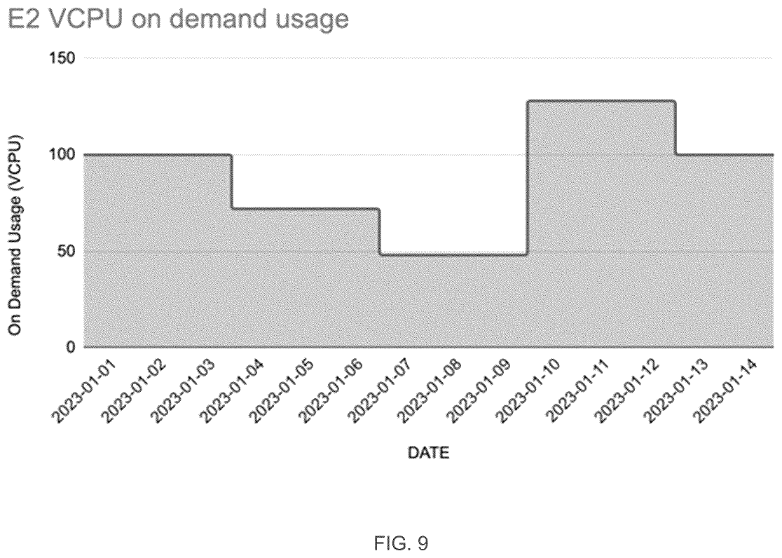

The on demand usage of the E2 VCPU for an exemplary two week period in January, 2023 is shown in FIG. 9. As shown in FIG. 9, the on-demand usage varies between 48 and 128 units in the two week period.

The daily cost for this workload is $6.432 per instance, with a total cost of $1,008.41 for the 2 week period, as shown in Table A provided on the following page:

TABLE A
(Usage As Shown in Fig. 9)

| | On Demand | |
|---|---|---|
| DATE | Usage (VCPU) | Daily cost |
| 2023 Jan. 1 | 100 | $80.40 |
| 2023 Jan. 2 | 100 | $80.40 |
| 2023 Jan. 3 | 100 | $80.40 |
| 2023 Jan. 4 | 72 | $57.89 |
| 2023 Jan. 5 | 72 | $57.89 |
| 2023 Jan. 6 | 72 | $57.89 |
| 2023 Jan. 7 | 48 | $38.59 |
| 2023 Jan. 8 | 48 | $38.59 |
| 2023 Jan. 9 | 48 | $38.59 |
| 2023 Jan. 10 | 128 | $102.91 |
| 2023 Jan. 11 | 128 | $102.91 |
| 2023 Jan. 12 | 128 | $102.91 |
| 2023 Jan. 13 | 100 | $80.40 |
| 2023 Jan. 14 | 100 | $80.40 |
| Total cost | | $1,000.18 |

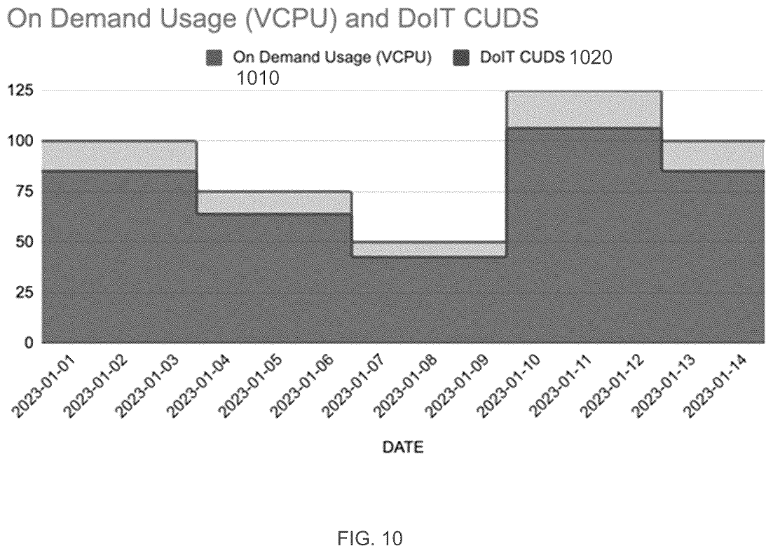

However, if this customer was using Flexsave, the optimizer would be able to apply Committed Use Discounts (“CUDs”) on a daily basis (see Slides 4-5 of Appendix A). Assuming that sufficient inventory is available, exemplary applicable daily CUDs are shown in FIG. 10. This example assumes that the optimizer targets a coverage of 85% of on demand usage. Thus, with reference to FIG. 10, there is shown the on-demand usage 1010, and the DoiT CUDs 1020. Because the DoiT CUDs utilize DoiT commitments, they are much cheaper (hence the value in using commitments), and the only on-demand fees the customer would pay is the difference between the on-demand usage 1010 and the DoiT CUDs 1020. The total costs to the customer are (i) the CUDs (shown in purple) plus (ii) the difference between the on-demand usage and the DoiT CUDs, which difference is the fractions of the orange boxes shown above the purple boxes in FIG. 10. Thus, by owning numerous commitments (CUDs) which it can share at will across its entire set of customers, Flexsave enjoys the economic benefits of CUDs, with sufficient scale not to waste the CUDs in underutilization.

The costs for on-demand usage, DoiT CUDs, and the total costs to this exemplary GCP user with Flexsave operative are all shown in Table B, provided below.

TABLE B
(DoiT CUDs usage, from FIG. 10)

| | On | | | | | |
|---|---|---|---|---|---|---|
| | Demand | | | | Cost for | Total |
| | Usage | DoiT | Net on- | Cost for | On | Daily |
| DATE | (VCPU) | CUDS | demand | CUDs | demand | Cost |
| 2023 Jan. 1 | 100 | 85 | 15 | $28.03 | $12.06 | $40.09 |
| 2023 Jan. 2 | 100 | 85 | 15 | $28.03 | $12.06 | $40.09 |
| 2023 Jan. 3 | 100 | 85 | 15 | $28.03 | $12.06 | $40.09 |
| 2023 Jan. 4 | 75 | 63.75 | 11.25 | $21.02 | $9.05 | $30.07 |
| 2023 Jan. 5 | 75 | 63.75 | 11.25 | $21.02 | $9.05 | $30.07 |
| 2023 Jan. 6 | 75 | 63.75 | 11.25 | $21.02 | $9.05 | $30.07 |
| 2023 Jan. 7 | 50 | 42.5 | 7.5 | $14.02 | $6.03 | $20.05 |
| 2023 Jan. 8 | 50 | 42.5 | 7.5 | $14.02 | $6.03 | $20.05 |
| 2023 Jan. 9 | 50 | 42.5 | 7.5 | $14.02 | $6.03 | $20.05 |
| 2023 Jan. 10 | 125 | 106.25 | 18.75 | $35.04 | $15.08 | $50.11 |
| 2023 Jan. 11 | 125 | 106.25 | 18.75 | $35.04 | $15.08 | $50.11 |
| 2023 Jan. 12 | 125 | 106.25 | 18.75 | $35.04 | $15.08 | $50.11 |
| 2023 Jan. 13 | 100 | 85 | 15 | $28.03 | $12.06 | $40.09 |
| 2023 Jan. 14 | 100 | 85 | 15 | $28.03 | $12.06 | $40.09 |
| Total | | | | | | $501.15 |

Comparing Table A with Table B, it is seen how when Flexsave technology is utilized by this example user, a savings of 50% can be achieved.

### AI Component Used in Flexsave GCP Processing

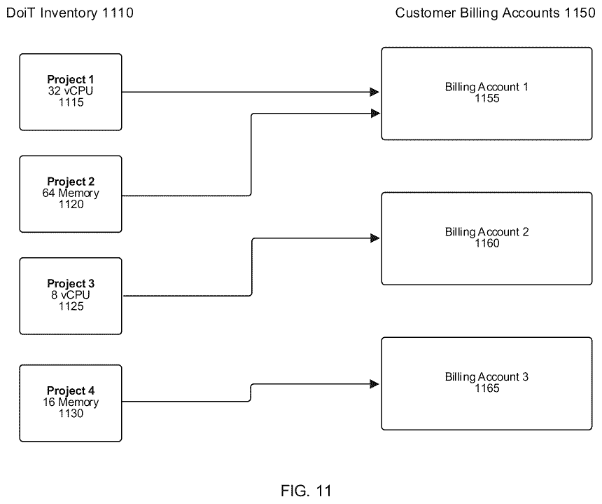

FIGS. 11 through 26 illustrate an AI component of an exemplary Google Cloud Platform (“GOP”) embodiment of Flexsave technology. The AI is used to calculate CUDs to purchase, as well as to optimize coverage to prevent/remove both under-provisioning and over-provisioning.

It is noted that while this disclosure describes example AWS and GCP embodiments, it is understood that the systems, methods and techniques of the present disclosure apply to any workload service provider (cloud or otherwise), where the ability of customers to purchase commitments with various types of CUDs is available.

FIG. 11 illustrates moving DoiT owned GCP projects into customers' billing accounts, in accordance with an example Flexsave embodiment for GCP. As noted above for the AWS example embodiment, customers may be provided with discounts on their workloads by applying CUDs. In embodiments, an example mechanism is as follows: a customer enables discount sharing in their billing account (“BA”). DoiT then creates GCP projects 1110 having CUDs and moves those projects 1110 to the customer BAs 1150. For example, as shown, there may be four DoiT projects held in DoiT inventory. Based on compatibility of the DoiT inventory with a given DoiT customer's billing account, for example, Projects 1 1115 and 2 1120 may be moved to a customer's BA 1 1155, Project 3 1125 may be moved to a customer's BA 2 1160, and Project 4 1130 may be moved to a customer's BA 3 1165.

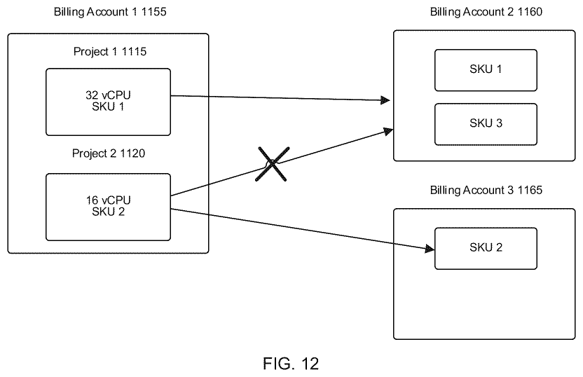

As illustrated in FIG. 12, CUDs must be purchased for a particular SKU. An SKU is specified by region, family type (e.g., N1), and hardware (e.g., VCPU). Thus, as shown in FIG. 12, while SKU 1 may be moved from Project 1 1115 of DoiT BA 1 1155 to customer BA 2 1160, as both BAs include SKU 1, SKU 2 of Project 2 1120 is incompatible with customer BA 2 1160, so SKU 2 cannot be moved from the DoiT BA 1 1155 to the customer BA 2 1160. However, Project 2 1120 is compatible with BA 3 1165, so SKU 2 can be moved from Project 2 1120 of the DoiT BA 1 1155 to the customer BA 3 1165. Thus, DoiT preferably has an inventory of various projects, with various SKUs in each project, so as to be able to move SKUs to compatible customer BAs as needed. As used herein, a SKU is a unique combination of region, family type and hardware. For a CUD to move from one billing account to another, the SKU must match. As also used herein, the term “workload” refers to SKU instances. Thus, for example, SKU us-east1, N1, VCPU for billing account A, is called a “workload.” As illustrated in FIG. 12, DoiT BA1 1155 contains Projects 1 1115 and 2 1120, which carry CUDs compatible with SKUs 1 and 2 respectively—while customer BA2 1160 has workloads running SKUs 1 and 3, and BA3 1165 has workloads running SKU 2. Thus, as noted, Project 1 1115 can, for example, be moved from DoiT BA1 1155 to customer BA2 1160 since customer BA2 1160 runs workloads compatible with that SKU. However, as also noted, DoiT Project 2 1120 can only be moved to customer BA3 1165 since it is only in BA 3 1165 that compatible workloads run.

In embodiments, an AI component may perform various functions. For example, the AI component may be used to generate CUD purchase recommendations. Additionally, for example, once CUDs are purchased, the AI component may be used to move CUDs from customers that are over-provisioned, to customers who are under provisioned. These AI functions are next described.

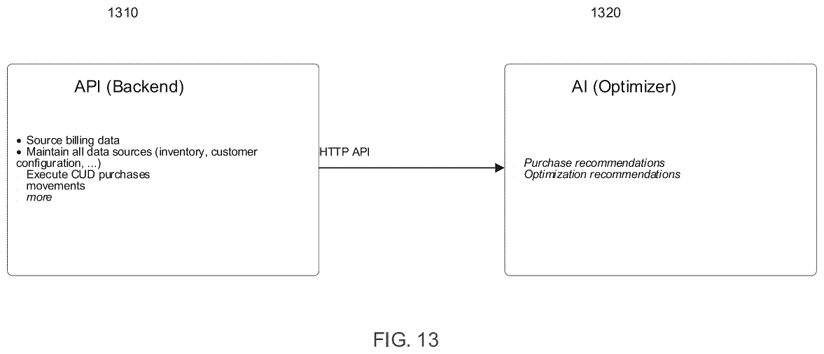

FIG. 13 depicts an exemplary system architecture for the GCP Flexsave embodiment. The exemplary system architecture includes both an API (or backend) 1310, as well as an AI Optimizer 1320. In embodiments, the API 1310 may handle source billing data, maintain all data sources, execute CUD purchases and CUD movements, and other functions, such as, for example, to create projects used for purchases, and to verify that projects remain in attached billing accounts. In embodiments, the AI Optimizer 1320 may generate purchase recommendations, as well as optimization recommendations, as shown.

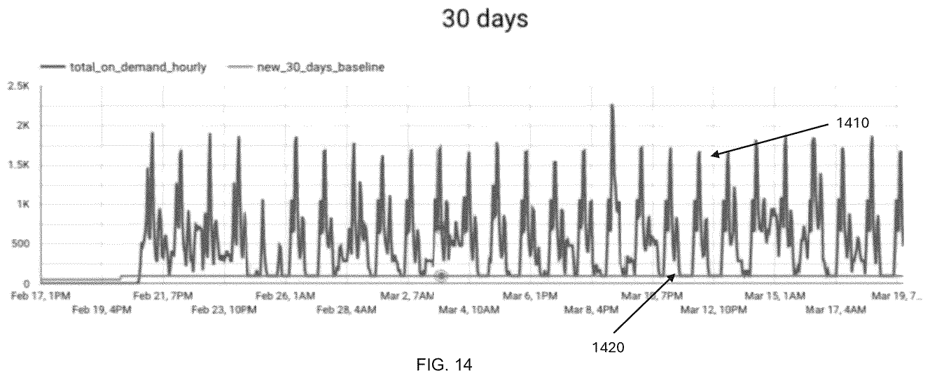

FIGS. 14-19, next described, illustrate how a stable usage baseline may be calculated, and then used to determine coverage, in accordance with various embodiments. As shown in FIG. 14, 30 days of data may be used, for example, to determine a stable usage baseline. The upper plot 1410 (from February 21 through March 19), shows the total on-demand hourly usage for the customer. In this example, it varies periodically throughout each 24-hour period. As shown, this plot 1410 may be used to set a new baseline 1420, which is the lower horizontal line above which the on-demand hourly plot does not drop below from February 21 onwards.

In some embodiments, the stable usage baseline 1420 may, for example, be modeled on the Google recommendations “maximize savings option.” This refers to the Google provided option to recommend CUD purchases (known as “Google Recommendations”). These recommendations include certain options as to how to determine an optimal value for recommendations, of which “maximize savings option” is one. When selected, “maximize savings option” calculates the number of CUDs to purchase for a SKU which maximizes the savings when cost of underutilization is also included (inasmuch as paying for a couple of hours of underutilization may still be worth it if this causes larger savings overall).

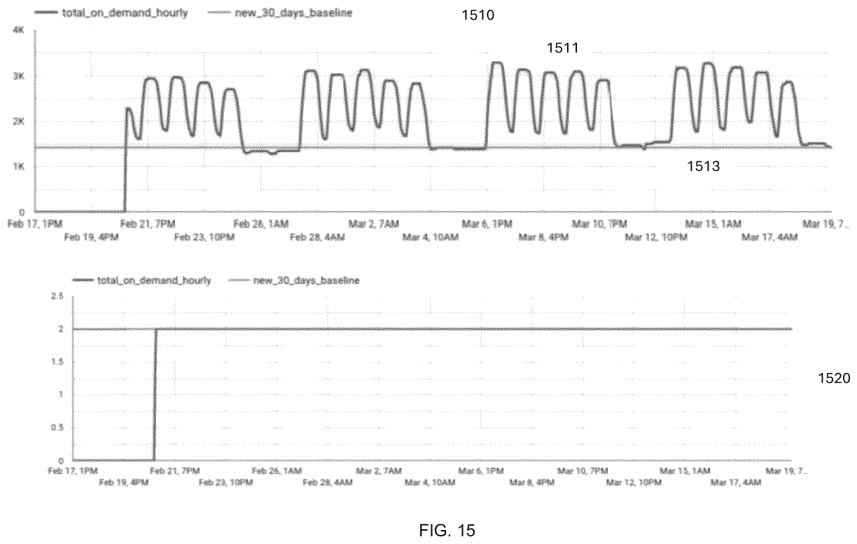

FIG. 15 illustrates two examples of determining a new 30-day baseline, one for a periodically varying on-demand curve, as in the example of FIG. 14, the other for an essentially constant on-demand curve (actually a horizontal line). In the upper plot 1510, in similar fashion to the example of FIG. 14, the on-demand plot 1511 varies significantly, with a periodic waveform. In this example, however, the pattern repeats (with some variation) every 7 days or so, varying between 1.6-1.7K and a bit over 3K, and has a period of days at the end of the pattern where usage is lowest at 1.4 K or slightly lower. Thus, a new baseline 1513 may be constructed from the on-demand plot 1511, and this is shown as the solid horizontal line 1513 underneath it, with a value of approximately 1.4K. In the lower plot of FIG. 15, namely plot 1520, the total on-demand hourly plot is unvarying, and simply has the value of 2. Thus, the new baseline is also set to 2.

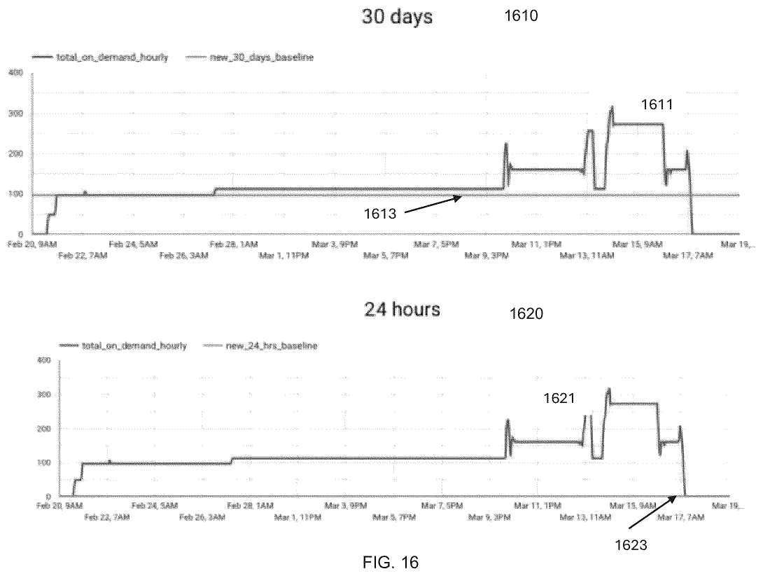

FIG. 16 illustrates an example technique to deal with capturing changes in the stable baseline, using what is termed a 24-hour validation process (but it need not be exactly 24-hours, which is merely exemplary), in accordance with various embodiments. With reference to the upper set of plots 1610, which depict 30 days of on-demand data 1611 and a corresponding stable baseline 1613, as in FIGS. 14 and 15, the on-demand plot 1611, at March 17, drops below the 30-day stable baseline 1613, which has been generated as described above with reference to FIGS. 14 and 15. The 30 day baseline 1613 has a value of 100, as shown in plots 1610. However, FIG. 16 also illustrates generation of a baseline for a 24-48 hour window to validate the current 30 day baseline. The 24-48 hour window may be used as a safety check for decreasing workloads. Thus, as shown in plot 1620, if the 24-hour baseline 1623 is less than the then prevailing 30-day baseline 1613, then the lower 24 hour baseline 1623 is used instead. In 1620, the 24-hour baseline 1623, calculated from March 17 through March 19, as shown, has a value of zero, so this value is used instead of the value for the 30 day baseline 1613 of plots 1610.

It is noted that in FIGS. 14-16 the stable baseline is chosen such that the on-demand plot is essentially always above it, as it varies. In alternate embodiments, it may be optimal to move the baseline slightly upwards, where the on-demand plot has a large dynamic range, with significant periods at a high value. Thus, although at some points the baseline will indicate overcoverage, for most of the time it is well under the values of the on-demand plot, and may be a better approximation for calculating a target baseline, as next described.

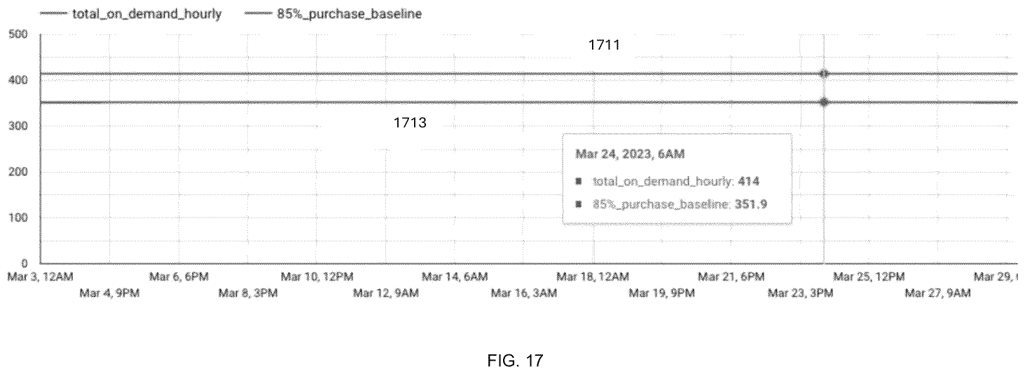

FIG. 17 illustrates purchasing CUDs within a pre-defined safety margin, in accordance with various embodiments. In embodiments, for target coverage, an example Flexsave system need not buy at the baseline for on-demand hourly activity, but rather can buy CUDs at 85% of that baseline. (The baseline calculated as described above with reference to FIGS. 14-16). Thus, as shown in FIG. 17, on Mar. 24, 2023, while the total on-demand hourly is 414.0 (shown in the upper curve 1711), the target coverage purchased is at, for example, 85% of that, or at 351.9 (shown in the lower curve 1713). In other embodiments a different value for the target baseline may be selected.

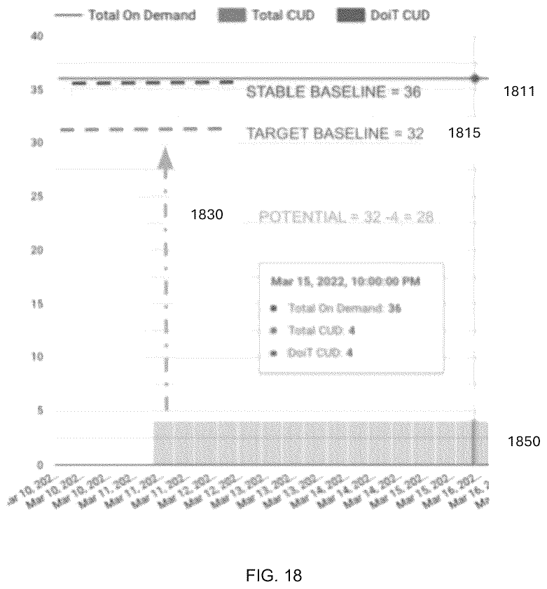

FIG. 18 illustrates, using a and a stable baseline 1811 and a related target baseline 1815, calculation of an available potential for all workloads. Here the potential is the difference between the target baseline 1815 and the actual value of DoiT CUDs now owned. In this example, the target baseline 1815 is 32/36 or 8/9ths (=88.88%) of the stable baseline 1811. Thus, for this example, the target baseline of 32, and the now extant set of DoiT CUDs 1850 having a value of 4, the potential CUDs to purchase 1830 equal 28, or the difference between the target baseline and the CUDs already on hand. The “total CUDs” and the “DoiT CUDs” are one and the same in this example, so they totally overlap, and are represented by the collection of CUDs 1850 having a value equal to 4.

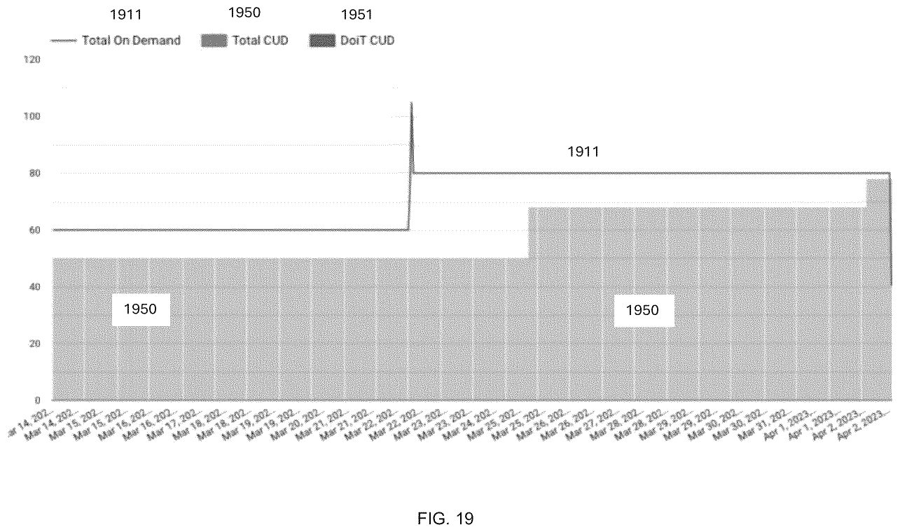

FIG. 19 depicts an example of coverage, in accordance with various embodiments. Here the total CUDs (shown in teal) 1950 and the DoiT CUDs (shown in pink) 1951, have the same value, and thus overlap, so they are difficult to distinguish in FIG. 19. As shown, both are at a pre-defined safety margin, which is less than the total on demand plot 1911 (blue line at top of the figure). Also seen in the figure, at the rightmost bin of FIG. 19, the total number of CUDs has increased, even though the total on demand usage for this customer has not changed, and, in fact, drops at the far right of the on demand plot 1911. This is because there is excess at another customer. Rather than generating waste, the excess CUDs were moved to this customer shown in FIG. 19, here going above the 85% target baseline, but still within the 100% of the stable baseline limit.

It is noted that, in general, Google recommendations are often inaccurate, inasmuch as recommendations for some workloads are missing, and even when they are provided, there is often a slow reaction to changes in workloads. The GCP algorithm seems to assume that CUDs remain stable, so their algorithm does not cope with on-demand workload movements, such as has been illustrated above for the varying on-demand plots of FIGS. 14, 15, 16 and 19.

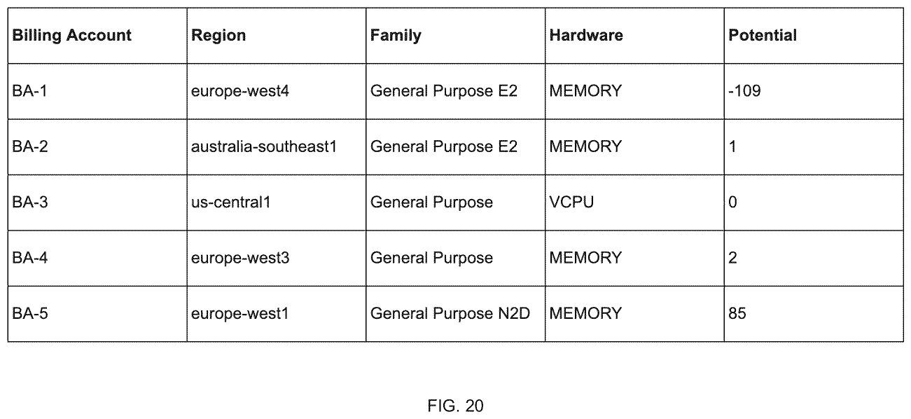

FIGS. 20-26, next described, illustrate optimization, in accordance with various embodiments. Constant workload changes generally may result in some customers being over-provisioned, and other customers being under-provisioned. In embodiments, to re-balance the system optimization may be run daily, to move over-provisioned CUDs to under-provisioned customers.

FIG. 20 reflects a potential calculation, pursuant to various example optimization steps, in accordance with various embodiments. Initially, a stable usage baseline is first determined for 24 hours, as described above. Next, a potential is calculated (which is the number of CUDs needed or in excess) using the target coverage for that stable usage baseline, as described above. The target coverage may be some percentage, less than 100%, of the stable usage baseline, as described above. This potential is shown in FIG. 20 for each BA, where a negative potential, as seen in BA-1, indicates an excess of CUDs. Finally, for example, the excess CUDs may be distributed to workloads which need it. As seen in FIG. 20, BA-1 has a large negative potential (excess CUDs—overprovisioned), while BA-5 has a large potential (under-provisioned).

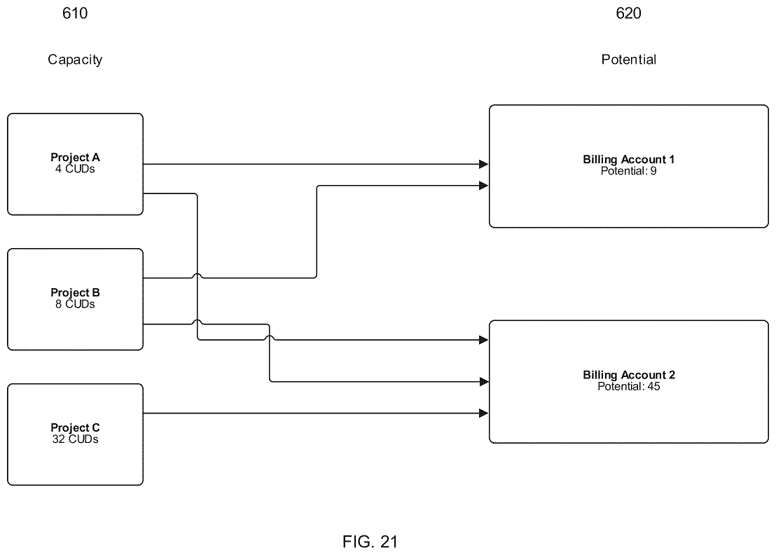

FIG. 21, which is the same as FIG. 6 described above, presented again here for convenience, illustrates an example distribution of CUDs, in accordance with various embodiments. It is noted that CUD allocation is not a trivial computational problem. It is an example of the classic bin packing problem, and, in embodiments, Google's OR-tools may be used for efficient allocation, such as, for example, a solver designed to tackle bin packing in the Google or-tools package. For example, in some embodiments, one may use the solver described here: https://developers.google.com/optimization/pack/bin_packing#:˜:text=Each%20item%20must%20be%20placed,items%20have%20to %20be%20packed.

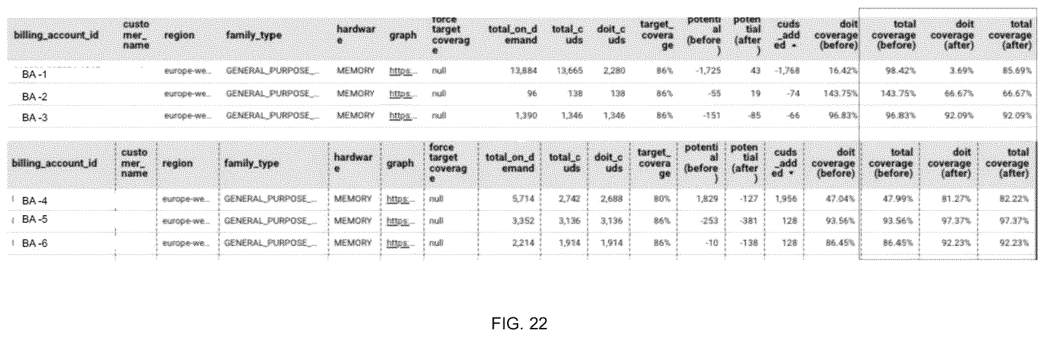

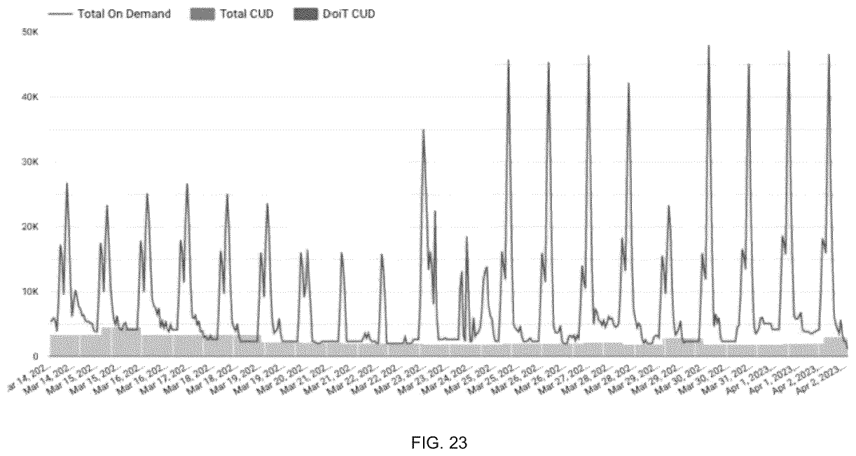

FIG. 22 illustrates an example where, for a given SKU, over-provisioned CUDs are moved to under-provisioned billing accounts. Thus, as shown, CUDs are removed from BAs 1-3, and CUDs are added to BAs 4-6, also as shown. In embodiments, an example optimizer may move excess CUDs to BAs where it finds space. For CUDs that cannot be moved (e.g., where there is no place to move them to, because all other customers already have enough CUDs), the excess CUDs may be left where they are, so that the excess may be used—at least most of, or a significant portion of, the time—if the workload is spiky, such as is illustrated in FIGS. 5 and 14, for example, or in FIG. 23, next described. Similarly, if all customers already have sufficient CUDs, the excess may be moved to the BAs with spiky workloads, such as that shown in 1510 of FIG. 15, from Bas which have stable workloads, such as that shown in FIG. 15 at 1520, inasmuch as there will generally be more demand for *portions* of a spiky workload over and above its stable baseline.

FIG. 23 depicts an exemplary highly “spiky” workload that has significant variation in total on-demand workload, as well as a robust dynamic range—thus often far exceeding its stable baseline. In such an approach the customer is not charged for the excess CUDs unless they are actually used, but this type of workload is a good candidate to be overprovisioned with excess CUDs, as described above. In the example of FIG. 23, just as in the case of FIG. 19, described above, here the total CUDs are equal to the DoiT CUDs, because the customer does not have their own CUDs. Also as in the case of FIG. 19, the teal colored “total CUDs” are a bit hard to discern from the pink colored DoiT CUDs, because there is a total overlap between these two categories, as the customer did not have any of their own CUDs previously.

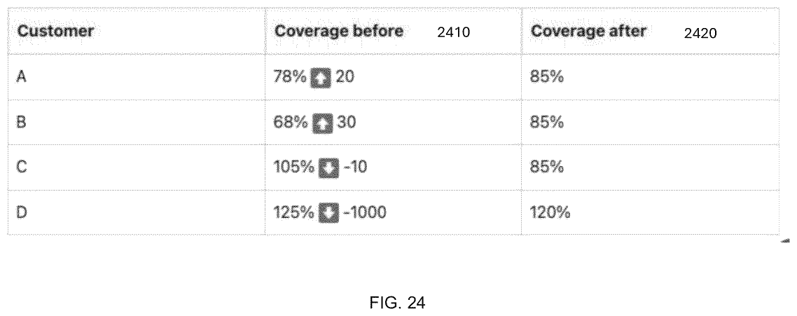

FIG. 24 depicts an exemplary first run of an example optimizer, to get each workload to its specified target coverage. The inputs to the first run of the example optimizer are the values in the “coverage before” column 2410, and the outputs from the optimizer are the values in the “coverage after” column 2420. In this example target coverage is 85%, which is, after the optimization first run, now met by customers A, B and C, but customer D remains over-provisioned. The CUDs by which each customer's coverage has changed, as shown by the (up or down pointing) arrows in column 2410, are relative to the sizes of their respective workloads, which are different for each customer. Thus, the corresponding percentage change reflected in column 2420 for each change in CUDs, will be for different actual numbers of CUDs. Thus, for customer A, an addition of 20 CUDs causes a percentage change of 78% to 85%, whereas an addition of 30 CUDs to customer B results in a change of 68% to 85%, and so on.

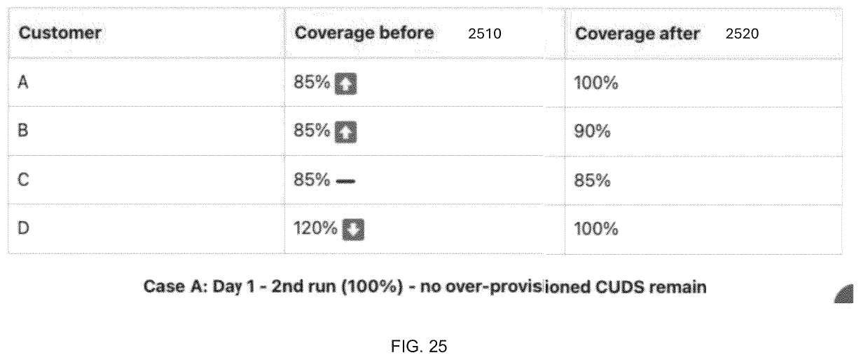

FIG. 25 depicts an exemplary second run of the example optimizer, to spread any over-provisioning amongst those customers who are not overprovisioned. Here, rather than have one over-provisioned workload (e.g., Customer D), and the others all below 100% provisioning, as shown in FIG. 24, at column 2420, after the first optimizer run, instead the over-provisioning of customer D is spread amongst the other workloads, such that Customers A, B and D are now in excess of the target coverage, as they are all at 100% of their respective stable baselines. However, given this second optimization run change, no over-provisioned workloads remain.

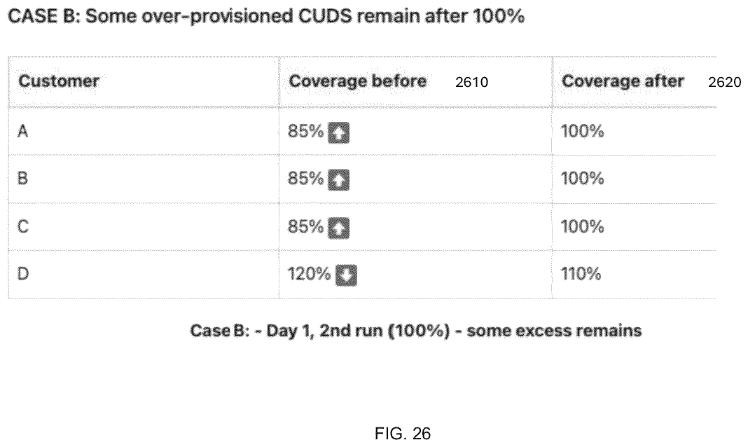

Alternatively, FIG. 26 illustrates another case, where over-provisioning of one or more workloads can still remain after 100% coverage is obtained for every (most) other workload(s). Here, in this example, all customers have 100% or more provisioning. It is here noted that, as above, the percentages are relative to the size of the workload. Consider workloads A, B and C each having 100 CUDs, and 15% having been added to each, thus each goes to size 115 and now has 100% coverage. Workload D can be a large workload with an on-demand value of 375, and have 450 CUDs, thus being 120% provisioned. In the example of FIG. 26, 45 CUDs (or 10% of the CUDs) may be removed from customer D, bringing it down by 10% and its coverage becoming 405/375, which is 108%. It is shown as 100% in column 2620, as an approximation, to use round numbers.

### Example Optimization Processes for Providing Coverage

In one or more embodiments, various optimization processes may be used to generate a set of recommendations for a given payer. In embodiments, the best approach for a given customer may likely be different than that for some other customer. This is because each customer will have different parameters based on their own usage patterns (such as, for example, 15th vs 5 h percentile, etc.).

In embodiments, various approaches may be utilized to find the Optimum best (w.r.t type of customer) possible (fixed) commitment for given timeframe.

In one approach, called “Moving Weekly Percentiles, moving weekly percentiles may be used. Here an n-day window function may be used to get a moving x-th-percentile (x=5). In various experiments, it was found that combining a 24-hour and a 7-day window can be highly effective.

In another approach, known as “Moving Optimum”, the optimal (straight) line of coverage for a selected (windowed) timeframe may be calculated. In embodiments, 1-day, 3-day, and 7-day windows may be used to obtain both aggressive and conservative estimates, and then a decision as to which one to use may be made based on the predictability features of a customer. For stable and predictable customers, it was seen that 1-day and 7-day recommendations should not differ significantly. However, whenever here is a big discrepancy between the 1-day and 7-day windows, in embodiments, the more conservative value may, for example, be chosen.

In embodiments, these windowed values may be combined using:
Simple Average—average estimate for all windows; and
Weighted Average—here weights are used to control which estimate to trust the most. In case of a predictable customer, for example, for whom changes in usage may be accurately anticipated, the weight for 1-day optimum may be increased to 100%, thus relying mostly on the predicted/enhanced data.

In embodiments, a function may also be used that calculates the most probable savings rate for each applicable unit increment. This can be done, for example, by averaging the performance of applicable units, at the same coverage level as in the past.

Thus, for example, when adding $1 to a desired commitment of $1.5 the average savings rate of applicable cost units between ($0.5-$1) and ($1-$1.5) would be calculated, for example.

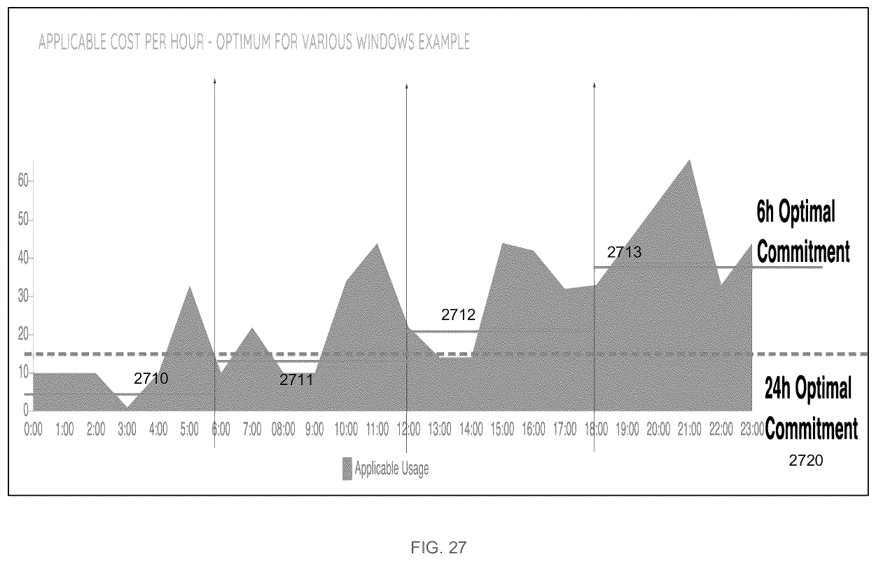

The example shown in FIG. 27 illustrates the idea behind an exemplary ‘moving optamum’ approach. In this example 24 hours of data are used, with a moving 6-hour long window. Thus, over the 24 hours, there are 4 separate windows. It is here seen that the optimal value for each of the four 6-hour windows 2710, 2711, 2712 and 2713 (shown as straight horizontal lines in each 6-hour window) differs from the other three 6-hour windows. Each 6-hour window optimal value also varies (and most of them significantly) from the 24-hour optimal commitment 2720, shown as a dashed line running across the entire plot.

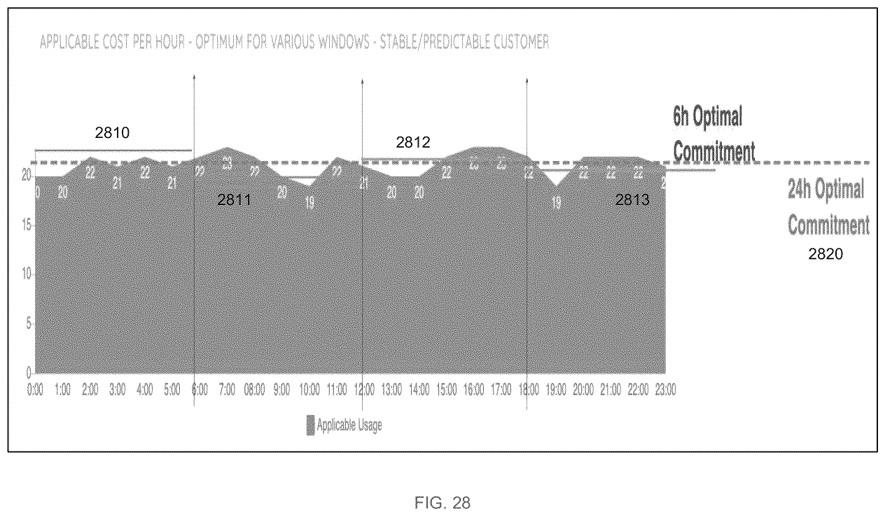

On the other hand, FIG. 28 illustrates an example customer that is stable/predictable. Thus, as shown in FIG. 28, the optimal values for the four 6-hour periods, namely 2810, 2811, 2812 and 2813, are very close to those for the 24-hour optimal commitment 2820.

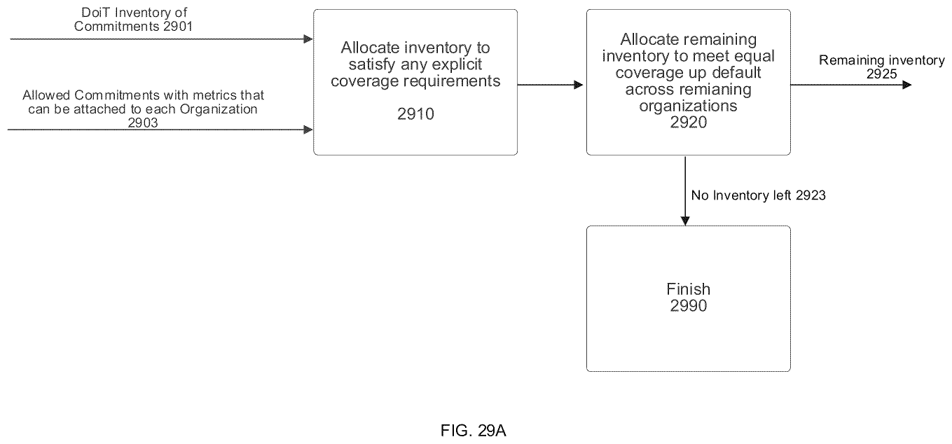

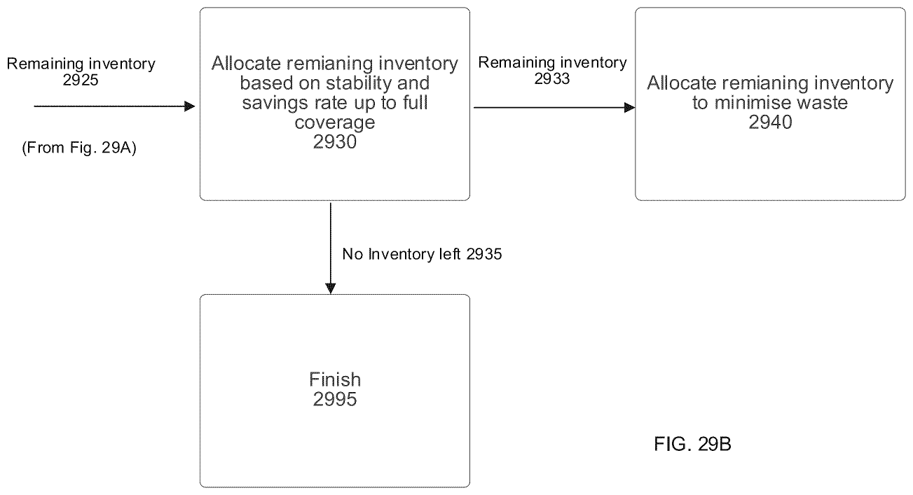

FIGS. 29A and 29B together illustrate a process flow diagram for allocating commitments inventory by a facilitator system, such as DoiT, using technology such as, for example, Flexsave or its equivalent. Beginning at the left side of FIG. 29A, the input data includes a DoiT inventory of commitments 2901, as well as allowed commitments with metrics that may be attached to each customer organization 2903. These inputs are fed to processing block 2910, where commitment inventory is allocated to satisfy any explicit coverage requirements. From block 2910, processing continues to block 2920, where remaining inventory is allocated to meet default coverage across remaining organizations. Default coverage here represents how much the facilitator system wants to cover by default—for example, as shown above, 85% —unless configured otherwise. This is done to both leave space for unexpected changes in workloads, and also to keep some space across organizations in case it is necessary to move some inventory back from other customers' reducing workloads.

From block 2920, the processing path depends upon whether or not there is still remaining inventory. Thus, although not shown, a query block is understood to immediately follow block 2920, which query block determines if there is any remaining inventory after allocating inventory to meet default coverage across remaining organizations, as done in block 2920. If the response to the query is no, then at 2923 processing moves to block 2990, and terminates. If, however, the response to the query is yes, and thus after the allocation at block 2920 there is still remaining commitments inventory, then, via 2925, the data regarding the remaining inventory is provided to block 2930, shown in FIG. 29B, next described, where processing continues.

Now with reference to FIG. 29B, at block 2930, the data regarding the remaining inventory received from block 2920, via 2925, is allocated based on stability and savings rate up to full coverage. Following block 2930, it is once again determined (via, although not shown, a query block immediately following block 2930) if there is any remaining inventory after the allocation of commitment inventory shown in block 2930. If the response to the query is yes, then at 2933 processing moves to block 2940, where the remaining inventory is allocated to minimize waste. If, however, following the allocations as shown in block 2930 there is no remaining inventory, as shown at 2935, then process flow moves to block 2995, where it terminates. Returning to block 2940, an example procedure to minimize waste would take into consideration the utilization of commitments above the stable baseline. This would be a combination of (i) how much the commitment can be utilized, and (ii) at what savings rate—the product of these values or data would inform an exemplary system how much waste would be generated, and the allocation of block 2940 would prioritize based on lowest waste. It is noted in this connection that the stable baseline only determines what is considered to be possible to cover, but—as seen in the various plots of on-demand usage discussed above, that does not mean that there isn't any spend over the stable baseline. This is especially true with the various “spiky” workload demand plots discussed above.

### Flexsave System Implementations

In some embodiments, all of the Flexsave systems may be hosted in a CSP's servers, such as, for example, those of Google Cloud Platform, inside a DoiT organization.

In embodiments, all of the relevant computing systems may be packaged into containers and hosted in, for example, GCP serverless offering, where almost all of this may be run, for example, in a service called CloudRun, and where some systems may use AppEngine. The fact that those workloads are containerized means that they can run other services if required—such as, for example, Google Kubernetes Engine (either as Google managed Kubernetes cluster or as GKE hosted CloudRun), or on regular virtual machines which can host containers. Technically, those workloads and computing systems may be run in any cloud provider who supports running containerized workloads.

In embodiments, a variety of smaller services in, for example, GCP, may be used to facilitate orchestration of work. For example, in some embodiments Cloud Composer may be used for orchestrating billing imports and recalculation jobs, Cloud Scheduler may be used for periodic jobs, Cloud Tasks may be used for reliable job execution scheduling, and Firestore may be used for configuration database, etc.

In embodiments, a second large part may be Google BigQuery, which is a petabyte scale data warehouse solution. In such embodiments this may be used for storage and processing of billing information, all the recalculated data, as well as the built-in ML capabilities.

In one example, all of the above software may be fully hosted in GCP by DoiT for both Flexsave for AWS, as well as for Flexsave for GCP, and any other embodiment of Flexsave for other cloud service providers.

For the regular Flexsave versions, customers do not host any infrastructure, nor perform any operations themselves. Flexsave simply require customer permissions to their infrastructure to make the necessary changes and read data—i.e., (i) download billing information data (such as, for the AWS example, the CUR) and (ii) attach/detach Flexsave/DoiT commitments to the customers' respective organizations.

For real-time embodiments, depending on the source of the information, customers may be required to configure something in their own environments so as to forward the relevant real-time data streams to DoiT for further processing. Even in such a scenario, the data would still then be processed on DoiT hardware.

In embodiments, the DoiT interface with Cloud Providers is always via public APIs of the relevant cloud. In some embodiments, a facilitator system such as Flexsave/DoiT need not own or operate any hardware, because all functionality is hosted by a cloud provider. However, it is understood that such a Flexsave implementation is not bound to the cloud provider in any way, and, if needed, Flexsave could fully operate on its own hardware in a datacenter—only requiring the same public API access.

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks may include local area network (LAN), wide area network (WAN), and the Internet, for example.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain, for example.

According to embodiments of the disclosure, the disclosure also provides a computer program product including computer programs. When the computer programs are executed by a processor, the steps of the method for sharing a resource or the method for creating a service described in the foregoing embodiments of the disclosure are implemented.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those of ordinary skill in the art should understand that various modifications, combinations, sub-combinations and substitutions can be made according to design requirements and other factors. Any modification, equivalent replacement and improvement made within the spirit and principle of this application shall be included in the protection scope of this application.

What is claimed:

1. A method comprising:
receiving, by a facilitator system, a billing data export (“BDE”) for a customer of a cloud service provider;
processing the BDE to determine a need for workload coverage in the customer's organization;
determining an optimal blend of commitments needed by the customer;
joining accounts owned by the facilitator system to the customer's organization in response to the commitments needed, wherein at least one commitment is held in each facilitator system's account; and
monitoring, at a predefined time interval, the customer's workload coverage needs to detect a change, and, in response, adding or subtracting accounts, or portions thereof, to the customer's organization.

2. The method of claim 1, wherein the determining further includes looking at a whole spend in the customer organization and determining an optimal blend of commitments needed by the customer, available inventory and risk associated with workloads.

3. The method of claim 1, wherein the joining accounts further comprises previously enabling consolidated billing for the customer organization.

4. The method of claim 1, wherein no workloads run in the accounts owned by the facilitator system that carry the commitments.

5. The method of claim 1, wherein the joining and adding and subtracting further include obtaining permissions from the customer to move projects into and out of the customer's organization.

6. A computer program product for managing cloud service provider commitments, the computer program product comprising:
a computer-readable storage medium having computer-readable program code embodied therewith, the computer-readable program code executable by one or more computer processors to:
receive, by a facilitator system, a BDE for a customer of a cloud service provider;
process the BDE to determine a need for workload coverage in the customer's organization;
determine an optimal blend of commitments needed by the customer;
join accounts owned by the facilitator system to the customer's organization in response to the commitments needed, wherein at least one commitment is held in each facilitator system's account; and
monitor, at a predefined time interval, the customer's workload coverage needs to detect a change, and, in response, add or subtract accounts, or portions thereof, to the customer's organization.

7. The computer program product of claim 6, wherein the determine further includes to look at a whole spend in the customer organization and determine an optimal blend of commitments needed by the customer, available inventory and risk associated with workloads.

8. The computer program product of claim 6, wherein the join accounts further comprises to previously enable consolidated billing for the customer organization.

9. The computer program product of claim 6, wherein no workloads are run in the accounts owned by the facilitator system that carry the commitments.

10. The computer program product of claim 6, wherein the join and the add and subtract further include to obtain permissions from the customer to move projects into and out of the customer's organization.

11. A system for optimizing coverage for one or more customers of a workload service provider, comprising:
at least one processor; and
memory containing instructions that, when executed, cause the at least one processor to, for each customer:
receive N-days of on-demand workload usage for the customer;
calculate a stable usage baseline based on the N-days of data;
calculate a target coverage for the customer, the target coverage being a pre-defined fraction of the stable usage baseline;
allocate a set of committed use discounts (“CUDs”) to cover the target coverage.

12. The system of claim 11, wherein the workload service provider is a cloud service provider.

13. The system of claim 11, wherein the pre-defined fraction is at least one of:
a number from 0.75 to 0.90; or
0.85.

14. The system of claim 11, wherein the N-days of data is either 30 or 31 days of data.

15. The system of claim 11, wherein the instructions, when executed, further cause the at least one processor to transfer CUDs from a facilitator system to the customer to meet the target coverage.

16. The system of claim 11, wherein the instructions, when executed, further cause the at least one processor to perform a recent hours baseline validation process to determine if the stable usage baseline has changed.

17. The system of claim 16, wherein the stable usage baseline is a first stable usage baseline, and wherein the recent hours validation process includes:
obtain a window of a most recent M-hours of on-demand workload usage data;
determine if the recent M-hours of on-demand workload usage data falls below the stable usage baseline; and
if yes, then:
generate a second stable usage baseline for the recent M-hours of on-demand workload usage; and
use the second stable usage baseline to calculate the target coverage for the customer.

18. The system of claim 11, wherein the one or more customers is a plurality of customers, and wherein the instructions, when executed, further cause the at least one processor to:
determine if any customer's CUDs exceed their target coverage;
in a first optimization, move CUDs between over-provisioned customer billing accounts to under-provisioned customer billing accounts.

19. The system of claim 18, wherein, in the first optimization, if all customer billing accounts are provisioned above their respective target coverage, then CUDs may be moved to a billing account up to the then operative stable usage baseline for that customer billing account.

20. The system of claim 18, wherein the instructions, when executed, further cause the at least one processor to:
determine if any customers remain overprovisioned after the first optimization; and
if yes:
reallocate the excess coverage based first on stability and savings rate up to full coverage, and then second based on minimization of waste.
